(19) United States
(12) Patent Application Publication
(10) Pub. No.: US 2013/0029122 A1
(43) Pub. Date: Jan. 31, 2013

(54) RESIN FILM AND ITS PRODUCTION METHOD, POLARIZER, AND LIQUID CRYSTAL DISPLAY DEVICE

(71) Applicants: Nobutaka FUKAGAWA, Kanagawa (JP); Yu NAITO, Kanagawa (JP); Yoshio ISHII, Kanagawa (JP); Jun TAKEDA, Kanagawa (JP); Akiko WATANO, Kanagawa (JP); Masaki NORO, Kanagawa (JP); Takeshi SENGA, Kanagawa (JP)

(72) Inventors: Nobutaka FUKAGAWA, Kanagawa (JP); Yu NAITO, Kanagawa (JP); Yoshio ISHII, Kanagawa (JP); Jun TAKEDA, Kanagawa (JP); Akiko WATANO, Kanagawa (JP); Masaki NORO, Kanagawa (JP); Takeshi SENGA, Kanagawa (JP)

(73) Assignee: FUJIFILM CORPORATION, Tokyo (JP)

(21) Appl. No.: 13/555,852

(22) Filed: Jul. 23, 2012

(30) Foreign Application Priority Data
Jul. 29, 2011 (JP) 2011-166958

(51) Int. Cl. C08L 1/12; B29C 41/42; B29C 41/32; B32B 3/00

(52) U.S. Cl. 428/216; 106/170.32; 264/334; 264/241

(57) ABSTRACT

A resin film containing a resin and from 0.01% by mass to 20% by mass, relative to the resin, of an organic acid satisfying (1) The organic acid comprises structure in which a polyalcohol bonds to a polycarboxylic acid via an ester bond, (2) The total number of the molecules of the polyalcohol and the polycarboxylic acid forming the organic acid is at least 3, and (3) The organic acid has at least one unsubstituted carboxylic acid derived from the polycarboxylic acid.

### CROSS-REFERENCE TO RELATED APPLICATIONS

The present application claims the benefit of priority from Japanese Patent Application No. 2011-166958, filed on Jul. 29, 2011, the contents of which are herein incorporated by reference in their entirety.

### BACKGROUND OF THE INVENTION

1. Field of the Invention

The present invention relates to a resin film and its production method, and to a polarizer and a liquid crystal display device using the resin film.

2. Description of the Related Art

With the recent tendency toward advancing TV use of liquid crystal display devices, the panel size of the devices is enlarged and high-definition and low-price liquid crystal display devices are much desired. Recently, in addition, outdoor use of display devices has increased, and liquid crystal display devices capable of withstanding outdoor use under more extreme weather condition than that expected for indoor use are desired.

It is generally known that the polarizer in a liquid crystal display device is so designed that a polarizing element formed by using polyvinyl alcohol (PVA) and iodine is sandwiched between polarizer protective films, and is thereby improved in point of the durability thereof. For such polarizer protective films, various resin films such as typically cellulose acylate film and acrylic resin film are used, and are desired to be tough and excellent in optical properties. However, conventional polarizer protective films are not satisfactory in point of the ability thereof to secure polarizing element durability under outdoor severe environments, especially under high-temperature high-humidity environments.

On the other hand, in case where a resin film for such polarizer protective films is produced according to a solution casting method, it is necessary to use a resin for which the material cost is low, for satisfying the recent requirement for price reduction. Consequently, it is desired to use inexpensive resins heretofore not used in the art for the reason that the peelability thereof from support in casting is not good and therefore the surface condition of the formed film is worsened in peeling or the optical properties of the formed film are ununiform (for example, cellulose acylate having a low degree of substitution), and to improve the peelability of the formed film to give inexpensive resin films.

Patent Reference 1 describes a method of casting a cellulose acylate film solution that contains at least one of (I) an organic phosphate salt having an alkyl group, an alkenyl group or an aralkyl group with from 4 to 22 carbon atoms, (II) an organic sulfonate salt having an alkyl group with from 4 to 16 carbon atoms and bonding to the sulfonic acid group via an aryleneoxy group and an alkylene group and (III) an organic polymer sulfonate salt having a sulfonic acid group in the recurring unit-having polymer side chain, as a peeling aid. The patent publication says that use of the peeling aid that satisfies the condition can reduce the peeling resistance of a cellulose acylate having a degree of acetylation of from 56 to 62% (total degree of acyl substitution of from 2.5 to 2.95 or so). In Examples in the patent publication, used are the Compound 6 shown in the patent publication (organic sodium phosphate salt having two alkyl groups each with 12 carbon atoms bonding to the phosphoric acid group), the Compound 2 shown therein (organic sodium sulfonate salt having two alkyl groups each with 9 carbon atoms bonding to the sulfonic acid group via an aryleneoxy group and an alkylene group) and the Compound 3 (organic polymer sodium sulfonate salt having a sulfonic acid group in the recurring unit-having polymer side chain), all as a peeling aid for cellulose acylate having a degree of acetylation of 61.9% (total degree of acyl substitution of 2.9).

Patent Reference 2 describes a method of casting a cellulose acylate film solution containing an acid having an acid dissociation exponent in an aqueous solution of from 1.93 to 4.50, or its alkali metal salt or alkaline earth metal salt. The patent publication describes use of an organic acid or an inorganic acid satisfying the condition as a peeling agent. In Examples in the patent publication, used are citric acid, tartaric acid, the Compound 6 described in Patent Reference 1 (organic sodium phosphate salt having an alkyl group with 12 carbon atoms and an alkyl group with 10 carbon atoms both bonding to the phosphoric acid group) and the Compound 9 (organic potassium sulfonate salt having an alkyl group with 16 carbon atoms bonding to the sulfonic acid group via a liking group or an aryleneoxy group and an alkylene group, as a peeling agent for cellulose acylate having a total degree of acyl substitution of from 2.7 to 3.0.

Patent Reference 3 describes a polarizer protective film using cellulose acetate flakes that contain an acid having an acid dissociation exponent in an aqueous solution of from 1.93 to 4.50. The patent publication describes use of an organic acid and an inorganic acid satisfying the condition as a peeling agent. In Examples in the patent publication, used are citric acid, citrate salts and sodium acetate as a peeling agent and calcium acetate and magnesium acetate as a heat-resistant stabilizer for cellulose acylate having a degree of acetylation of from 55.2 to 61.3% (total degree of acyl substitution of from 2.5 to 2.9 or so).
[Patent Reference 1] JP-A 61-243837
[Patent Reference 2] JP-A 2002-179838
[Patent Reference 3] JP-A 10-316791

### SUMMARY OF THE INVENTION

The present invention has been made in consideration of the current situation as above, and its object is to provide a resin film having improved peelability from support in solution casting for resin film production and capable of enhancing the durability of polarizer, and to provide a method for producing the resin film at high producibility and low production equipment maintenance cost. Another object of the invention is to provide a polarizer and a liquid crystal display device using the film.

The present inventors have assiduously studied for the purpose of solving the above-mentioned problems and, as a result, have found that, when an organic acid in which a polyalcohol and a polycarboxylic acid form an ester bond and which satisfies specific requirements is used as a peeling agent, then a resin film having improved peelability from support in solution casting film production and capable of enhancing the durability of polarizer can be obtained. In addition, using the organic acid in which a polyalcohol and a polycarboxylic acid form an ester bond and which satisfies specific requirements as above, the inventors have further found out a method for producing a resin film at high producibility and low production equipment maintenance cost, in which the resin film produced has improved peelability from support in solution casting film production and can enhance the durability of polarizer can be obtained and in which the production equipment used is free from the problem of corrosion by the organic acid used therein. Specifically, the above-mentioned problems can be solved by the following means.

[1] A resin film comprising a resin and from 0.01% by mass to 20% by mass, relative to the resin, of an organic acid satisfying the following requirements (1) to (3):
(1) The organic acid comprises structure in which a polyalcohol bonds to a polycarboxylic acid via an ester bond,
(2) The total number of the molecules of the polyalcohol and the polycarboxylic acid forming the organic acid is at least 3, and
(3) The organic acid has at least one unsubstituted carboxylic acid derived from the polycarboxylic acid.
[2] Preferably, the resin film of [1] comprises cellulose acylate in an amount of from 5 to 99% by mass as the resin.
[3] Preferably, in the resin film of [2], the total degree of acyl substitution of the cellulose acylate is 1.0 or more to less than 2.6.
[4] Preferably, in the resin film of any one of [1] to [3], the concentration of the organic acid satisfying the requirements (1) to (3) in the region to a depth of 5 μm from one film surface, and the concentration of the organic acid satisfying the requirements (1) to (3) in the region to a depth of 5 μm from the other film surface satisfy the relationship of the following formula (4):

1.2≦(mean concentration of the organic acid in the region to a depth of 5 μm from the film surface on the side of the film on which the concentration of the organic acid is higher)/(mean concentration of the organic acid in the region to a depth of 5 μm from the film surface on the side of the film on which the concentration of the organic acid is lower)≦5.0. (4)

[5] A method for producing a resin film, which comprises casting a dope that comprises a resin and from 0.01% by mass to 20% by mass, relative to the resin, of an organic acid satisfying the following requirements (1) to (3), onto a metal support to form a dope film thereon, and peeling the dope film from the metal support:
(1) The organic acid comprises structure in which a polyalcohol bonds to a polycarboxylic acid via an ester bond,
(2) The total number of the molecules of the polyalcohol and the polycarboxylic acid forming the organic acid is at least 3, and
(3) The organic acid has at least one unsubstituted carboxylic acid derived from the polycarboxylic acid.
[6] Preferably, in the production method for a resin film of [5], the resin comprises cellulose acylate in an amount of from 5 to 99% by mass.
[7] Preferably, in the production method for a resin film of [6], the total degree of acyl substitution of the cellulose acylate is 1.0 or more to less than 2.6.
[8] Preferably, in the production method for a resin film of anyone of [5] to [7], dopes for at least two layers are co-cast onto the metal support, and the organic acid satisfying the requirements of (1) to (3) is added to any one of the dope for the layer to be kept in contact with the metal support surface or the dope for the layer to be on the air interface side.
[9] A resin film produced according to the resin film production method of any one of [5] to [8].
[10] A polarizer protective film comprising the resin film of any one of [1] to [4] and [9].
[11] A polarizer comprising at least one polarizer protective film of [10].
[12] A liquid crystal display device comprising at least one of the polarizer protective film of [10] or the polarizer of [11].

According to the invention, there is provided a resin film having improved peelability from metal support in solution casting for resin film production and capable of enhancing the durability of polarizer, and there is provided a method for producing the resin film at high producibility and low production equipment maintenance cost. Further, according to the invention, there is provided a polarizer using the film and securing high polarizer durability. When the film-having polarizer is incorporated into a liquid crystal display device, there is provided a liquid crystal display device having improved durability in high-temperature high-humidity environments.

### BRIEF DESCRIPTION OF THE DRAWINGS

FIG. 1 is a schematic cross-sectional view of one example of the liquid crystal display device of the invention in which 11 and 12 are polarizing element, 13 is liquid crystal cell, 14 is cellulose acylate film of Examples and Comparative Examples and 15 is cellulose acylate film of Examples and Comparative Examples.

FIG. 2 is a schematic view showing one example of a casting mode to form a three-layered cellulose acylate film according to a simultaneous co-casting method using a co-casting die in which 1A is dope for skin A layer (support-side surface layer), 1B is cope for skin B layer (air-side surface layer), 2 is dope for core layer (base layer), 3 is casting die and 4 is metal support.

### DETAILED DESCRIPTION OF THE INVENTION

The resin film of the invention and its production method, and additives to be used for the film are described in detail hereinunder.

The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### [Resin Film]

The resin film of the invention (hereinafter this may be referred to as the film of the invention) comprises a resin and from 0.01% by mass to 20% by mass, relative to the resin, of an organic acid satisfying the following requirements (1) to (3):

(1) The compound comprises a structure of a polyalcohol and a polycarboxylic acid forming an ester bond and bonding to each other via the bond therein,
(2) The total number of the molecules of the polyalcohol and the polycarboxylic acid forming the compound is at least 3,
(3) The compound has at least one unsubstituted carboxylic acid derived from the polycarboxylic acid.

The invention is described concretely hereinunder with reference to preferred embodiments of the film of the invention.

### <Resin>

Not specifically defined, the resin for use for the film of the invention may be any one usable for known polarizer protective films. Above all, in the invention, preferred is a cellulose acylate or an acrylic resin. According to the invention, even inexpensive resins heretofore not used in the art for the reason that the peelability thereof from metal support in casting is not good can be used for solution casting for film formation, and therefore in the invention, preferred is use of inexpensive resins of cellulose acylates or acrylic resins.

The resins usable for the film of the invention are described below.

### (Cellulose Acylate)

The starting cellulose for cellulose acylate includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8, and cellulose materials described in these may be used here.

Only one or two or more different types of acyl groups may be used, either singly or as combined, in the cellulose acylate for the film of the invention. Preferably, the film of the invention has an acyl group with from 2 to 4 carbon atoms as the substituent therein. In case where the acylate has two or more different types of acyl groups, preferably, one of them is an acetyl group; and as the acyl group having from 2 to 4 carbon atoms, preferred is a propionyl group or a butyryl group. The cellulose acylate of the type can form a solution having good solubility, and in particular, it forms a good solution in a non-chlorine organic solvent. Another advantage is that the cellulose acylate can form a solution having a low viscosity and having good filterability.

The cellulose acylate preferably used in the invention is described in detail. The β-1,4-bonding glucose unit to constitute cellulose has a free hydroxyl group at the 2-, 3- and 6-positions. The cellulose acylate is a polymer produced by esterifying a part or all of those hydroxyl groups in cellulose with an acyl group. The degree of acyl substitution means the total of the ratio of acylation of the hydroxyl group in cellulose positioned in the 2-, 3- and 6-positions in the unit therein. In case where the hydroxyl group is 100% esterified at each position, the degree of substitution at that position is 1.

Preferably, the total degree of acyl substitution of the cellulose acylate is from 1.0 to 2.97, more preferably from 1.0 to less than 2.6, even more preferably from 1.5 to 2.6. A cellulose acylate having a low degree of substitution is excellent in optical properties though relatively inexpensive, but when it is formed into a film according to an ordinary solution casting method, the peelability of the formed film from the metal support is poor; and for this reason, the cellulose acylate of the type has not heretofore been used in the art for film formation. In the invention, even such an inexpensive cellulose acylate can be favorably used.

Not specifically defined, the acyl group having at least 2 carbon atoms in the cellulose acylate for use in the invention may be an aliphatic group or an aryl group. For example, the ester is an alkylcarbonyl ester, an alkenylcarbonyl ester, an aromatic carbonyl ester or an aromatic alkylcarbonyl ester of cellulose, in which the acyl group may be further substituted. Preferred examples of the acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group, a cinnamoyl group, etc. Of those, preferred are an acetyl group, a propionyl group, a butanoyl group, a dodecanoyl group, an octadecanoyl group, a tert-butanoyl group, an oleoyl group, a benzoyl group, a naphthylcarbonyl group, and a cinnamoyl group; more preferred are an acetyl group, a propionyl group and a butanoyl group (acyl group having from 2 to 4 carbon atoms). Even more preferred is an acetyl group (in this case, the cellulose acylate is a cellulose acetate).

In case where an acid anhydride or an acid chloride is used as the acylating agent for acylation of cellulose, an organic acid such as acetic acid, or methylene chloride or the like may be used as the organic solvent to be the reaction solvent.

In case where the acylating agent is an acid anhydride, the catalyst is preferably a protic catalyst such as sulfuric acid; and in case where the acylating agent is an acid chloride (e.g., CH₃CH₂COCl), a basic compound may be used as the catalyst.

A most popular industrial-scale production method for a mixed fatty acid ester of cellulose comprises acylating cellulose with a mixed organic acid component that contains a fatty acid (e.g., acetic acid, propionic acid, valeric acid) corresponding to an acetyl group or other acyl group, or its acid anhydride.

The cellulose acylate for use in the invention can be produced, for example, according to the method described in JP-A 10-45804.

Preferably, the film of the invention contains, as the resin, cellulose acylate in an amount of from 5 to 99% by mass from the viewpoint of the moisture permeability thereof, more preferably from 20 to 99% by mass, even more preferably from 50 to 95% by mass. However, the film of the invention may contain, as the resin, cellulose acylate in an amount of 100% by mass.

As the resin usable for the film of the invention in addition to cellulose, there is mentioned an acrylic resin.

### <Peeling Promoter>

### (Organic Acid Satisfying Requirements (1) to (3))

The film of the invention contains an organic acid satisfying the following requirements (1) to (3), in an amount of from 0.01% by mass to 20% by mass relative to the resin therein.

(1) The compound contains a structure of a polyalcohol and a polycarboxylic acid forming an ester bond and bonding to each other via the bond therein,
(2) The total number of the molecules of the polyalcohol and the polycarboxylic acid forming the compound is at least 3,
(3) The compound has at least one unsubstituted carboxylic acid derived from the polycarboxylic acid.

In the organic acid satisfying the requirements (1) to (3), the unsubstituted carboxyl group acts to improve the peelability of the formed film from the solution casting equipment (metal support on which dope is cast), and therefore, in the invention, the organic acid satisfying the requirements (1) to (3) can be used as a peeling promoter.

Further, the unsubstituted carboxyl group adheres to the metal surface of support and the polyalcohol moiety or the hydrophobic group moiety with which the polyalcohol moiety is substituted blocks the metal surface of support from the oxidizing agent such as oxygen, and consequently, as compared with an organic acid not containing the polyalcohol moiety or the hydrophobic group moiety with which the polyalcohol moiety is substituted, the specific organic acid satisfying the above-mentioned requirements for use in the invention can more effective prevent the metal surface from being corroded.

The organic acid satisfying the requirements (1) to (3) and capable of being used as a peeling promoter in the film of the invention, and any other peeling promoter capable of being used along with the organic acid are described below.

Not specifically defined, preferred examples of the polycarboxylic acid for use in the organic acid satisfying the requirements (1) to (3) include, for example, succinic acid, citric acid, tartaric acid, diacetyltartaric acid, malic acid, adipic acid.

In the organic acid satisfying the requirements (1) to (3), the number of the molecules of the polycarboxylic acid is preferably from 1 to 20, more preferably from 1 to 15, even more preferably from 1 to 10.

The polyalcohol for use in the organic acid satisfying the requirements (1) to (3) includes adonitol, arabitol, ethylene glycol, diethylene glycol, triethylene glycol, tetraethylene glycol, 1,2-propanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, glycerin, etc. Of those, preferred is glycerin.

Preferably, the number of the molecules of the polyalcohol in the organic acid satisfying the requirements (1) to (3) is from 1 to 20, more preferably from 1 to 15, even more preferably from 1 to 10.

The organic acid satisfying the requirements (1) to (3) may have, in addition to the polyalcohol and the polycarboxylic acid constituting the organic acid, a structure in which a monoacid having at least 4 carbon atoms and having a substituent forms an ester bond with a part of the hydroxyl group of the polyalcohol. Specific examples of the monoacid having at least 4 carbon atoms and having a substituent are mentioned below. In the monoacid having at least 4 carbon atoms and having a substituent, the substituent means R of the substituent-having monoacid with at least 4 carbon atoms, RCOOH.

### <<Fatty Acid>>

Caproic acid, heptylic acid, caprylic acid, pelargonic acid, lauric acid, myristic acid, palmitic acid, stearic acid, oleic acid, linolic acid, linolenic acid, ricinoleic acid, undecanoic acid.

### <<Alkylsulfuric Acid>>

Myristylsulfuric acid, cetylsulfuric acid, oleylsulfuric acid.

### <<Alkylbenzenesulfonic Acid>>

Dodecylbenzenesulfonic acid, pentadecylbenzenesulfonic acid.

### <<Alkylnaphthalenesulfonic Acid>>

Sesquibutylnaphthalenesulfonic acid, diisobutylnaphthalenesulfonic acid.

Of those, preferred are monoacids of fatty acids having at least 4 carbon atoms and having a substituent; more preferred are caprylic acid, lauric acid, stearic acid, oleic acid; and even more preferred is oleic acid.

In the organic acid satisfying the requirements (1) to (3), the number of the molecules of the monoacid having at least 4 carbon atoms and having a substituent is preferably from 0 to 4, more preferably from 0 to 3, even more preferably from 0 to 2.

Preferably, in the organic acid satisfying the requirements (1) to (3), the total number of the molecules of the polyalcohol and the polycarboxylic acid that forms the compound is at least 3, more preferably from 3 to 30, even more preferably from 3 to 20.

In the organic acid satisfying the requirements (1) to (3), the proportion of the polycarboxylic acid, the polyalcohol and the monoacid having at least 4 carbon atoms and having a substituent is not specifically defined. In the organic acid, two or more unsubstituted hydroxyl groups may remain, or one unsubstituted hydroxyl group may remain therein.

The organic acid satisfying the requirements (1) to (3) has at least one unsubstituted carboxyl group derived from the polycarboxylic acid, but preferably has from 1 to 40, even more preferably from 1 to 30 unsubstituted carboxyl groups derived from the polycarboxylic acid.

One alone or two or more different types of the organic acid satisfying the requirements (1) to (3) may be used here either singly or as combined. As the case may be, the organic acid satisfying the requirements (1) to (3) may be dissociated, and also as the case may be, the acid may form a salt with any arbitrary metal ion.

Preferred compound examples of the organic acid satisfying the requirements (1) to (3) for use in the invention are described below.

Preferred are organic acids (partial condensates of organic acids) having the composition mentioned below.

TABLE 1

| | | | Monoacid having at |
|---|---|---|---|
| | | Polycarboxylic | least 4 carbon atoms |
| | Polyalcohol | Acid | and having substituent |
| Organic Acid | glycerin | citric acid | oleic acid |
| Condensate A-1 | 2 to 3 | 1 to 2 | 0 to 1 |
| Condensate A-2 | 2 to 3 | 1 to 2 | 1 to 2 |
| Condensate A-3 | 2 to 4 | 2 to 3 | 0 to 1 |
| Condensate A-4 | 2 to 4 | 2 to 3 | 1 to 2 |
| Condensate A-5 | 5 to 6 | 3 to 4 | 1 to 2 |
| Condensate A-6 | 7 to 8 | 3 to 4 | 1 to 2 |

TABLE 2

| | | | Monoacid having at |
|---|---|---|---|
| | | Polycarboxylic | least 4 carbon atoms |
| | Polyalcohol | Acid | and having substituent |
| Organic Acid | glycerin | citric acid | caprylic acid |
| Condensate B-1 | 2 to 3 | 1 to 2 | 0 to 1 |
| Condensate B-2 | 2 to 3 | 1 to 2 | 1 to 2 |
| Condensate B-3 | 2 to 4 | 2 to 3 | 0 to 1 |
| Condensate B-4 | 2 to 4 | 2 to 3 | 1 to 2 |
| Condensate B-5 | 5 to 6 | 3 to 4 | 1 to 2 |
| Condensate B-6 | 7 to 8 | 3 to 4 | 1 to 2 |

TABLE 3

| | | | Monoacid having at |
|---|---|---|---|
| | | Polycarboxylic | least 4 carbon atoms |
| | Polyalcohol | Acid | and having substituent |
| Organic Acid | glycerin | citric acid | lauric acid |
| Condensate C-1 | 2 to 3 | 1 to 2 | 0 to 1 |
| Condensate C-2 | 2 to 3 | 1 to 2 | 1 to 2 |
| Condensate C-3 | 2 to 4 | 2 to 3 | 0 to 1 |
| Condensate C-4 | 2 to 4 | 2 to 3 | 1 to 2 |
| Condensate C-5 | 5 to 6 | 3 to 4 | 1 to 2 |
| Condensate C-6 | 7 to 8 | 3 to 4 | 1 to 2 |

TABLE 4

| | | | Monoacid having at |
|---|---|---|---|
| | | Polycarboxylic | least 4 carbon atoms |
| | Polyalcohol | Acid | and having substituent |
| Organic Acid | glycerin | citric acid | stearic acid |
| Condensate D-1 | 2 to 3 | 1 to 2 | 0 to 1 |
| Condensate D-2 | 2 to 3 | 1 to 2 | 1 to 2 |
| Condensate D-3 | 2 to 4 | 2 to 3 | 0 to 1 |
| Condensate D-4 | 2 to 4 | 2 to 3 | 1 to 2 |
| Condensate D-5 | 5 to 6 | 3 to 4 | 1 to 2 |
| Condensate D-6 | 7 to 8 | 3 to 4 | 1 to 2 |

The amount of the organic acid satisfying the requirements (1) to (3), which is contained in the film of the invention, is in a ratio of from 0.01% by mass to 20% by mass relative to the resin, preferably from 0.05% by mass to 10% by mass, more preferably from 0.1% by mass to 5% by mass. In case where a mixture of the organic acids satisfying the requirements (1) to (3) is contained in the film of the invention, the amount thereof to be contained in the film of the invention means the total amount of all the organic acids satisfying the requirements (1) to (3).

When the amount is at least 0.01% by mass, then the effect of the acid for enhancing the durability of polarizer and for enhancing the peelability of the film from support would be sufficient. Even when the amount is from 0.01 to 0.1% by mass or so, the effect of enhancing the peelability of the film from support could be expected by combining the acid with a peelability enhancing technique of cooling the peeling site of support. When the amount is at most 20% by mass, then the organic acid would hardly bleed out in high-temperature high-humidity environments and the cross transmittance of the polarizer that comprises the film of the invention would hardly increase; and for these reasons, the embodiment is preferred.

The distribution of the organic acid satisfying the requirements (1) to (3) in the film of the invention is not specifically defined.

Preferably, in the film of the invention, the concentration of the organic acid satisfying the requirements (1) to (3) in the region to a depth of 5 μm from one film surface, and the concentration of the organic acid satisfying the requirements (1) to (3) in the region to a depth of 5 μm from the other film surface satisfy the relationship of the following formula (4), from the viewpoint of preventing the molecular weight of the resin in the film from reducing:

1.2 (mean concentration of the organic acid in the region to a depth of 5 μm from the film surface on the side of the film on which the concentration of the organic acid is higher)/(mean concentration of the organic acid in the region to a depth of 5 μm from the film surface on the side of the film on which the concentration of the organic acid is lower)≦5.0. (4)

The lower limit of the inequality (4) is preferably 1.5, more preferably 2.0. The upper limit of the inequality (4) is preferably 4.5, more preferably 4.0.

### (Other Peeling Promoter)

In addition to the organic acid satisfying the requirements (1) to (3), any known peeling promoter may be added to the film of the invention. As the known peeling promoter, for example, preferably employable here are the compounds described in JP-A 2006-45497, paragraphs [0048] to [0069].

The peeling promoter is preferably an organic acid, a polycarboxylic acid ester, a surfactant or a chelating agent.

As the polycarboxylic acid ester, preferred is use of the compounds described in JP-A 2006-45497, paragraph [0049].

As the surfactant, preferred is use of the compounds described in JP-A 2006-45497, paragraphs [0050] to [0051].

The chelating agent is a compound capable of chelating a polyvalent ion, for example, a metal ion such as an iron ion or an alkaline earth metal ion such as a calcium ion; and as the chelate agent, usable here are the compounds described in JP-B 6-8956, JP-A 11-190892, 2000-18038, 2010-158640, 2006-328203, 2005-68246, 2006-306969.

The total amount of all the peeling promoters capable of being contained in the film of the invention is preferably in a ratio of from 0.01% by mass (100 ppm) to 20% by mass (200000 ppm) relative to the resin in the film, more preferably from 0.01% by mass (100 ppm) to 15% by mass (150000 ppm), even more preferably from 0.01% by mass (100 ppm) to 10% by mass (100000 ppm), still more preferably from 0.03% by mass (300 ppm) to 10% by mass (100000 ppm), further more preferably from 0.1% by mass (1000 ppm) to 5% by mass (50000 ppm).

### <Other Additives>

In addition to the above-mentioned peeling promoter, any other additive may be added to the film of the invention. For example, the additive includes a polycondensation polymer, a retardation regulator (retardation enhancer, retardation reducer); a plasticizer such as phthalate, phosphate; a UV absorbent; an antioxidant; a mat agent, etc.

### (Polycondensation Polymer)

Preferably, the film of the invention contains a polycondensation polymer from the viewpoint of reducing the haze thereof.

As the polycondensation polymer, herein widely usable is a high-molecular additive known as an additive to cellulose acylate films. The content of the additive is preferably from 1 to 35% by mass relative to the cellulose resin in the film, more preferably from 4 to 30% by mass, even more preferably from 10 to 25% by mass.

The high-molecular additive that is used as the polycondensation polymer in the film of the invention is a compound having a recurring unit therein, and is preferably one having a number-average molecular weight of from 700 to 10000. The high-molecular additive has the function of promoting the solvent evaporation speed in a solution casting method, and the function of reducing the residual solvent amount therein. Further, the additive exhibits various useful effects from the viewpoint of improving the properties of the film, for example, improving the mechanical properties of the film, imparting softness to the film, imparting water absorption resistance thereto, reducing the moisture permeability of the film, etc.

The number-average molecular weight of the high-polymer additive, or that is, the polycondensation polymer for use in the invention is more preferably from 700 to 8000, even more preferably from 700 to 5000, still more preferably from 1000 to 5000.

The polycondensation polymer, or that is, the high-molecular additive for use in the invention is described in detail hereinunder with reference to its specific examples given below. Needless-to-say, however, the high-molecular additive of the polycondensation polymer for use in the invention is not limited to those mentioned below.

Preferably, the polycondensation polymer is a non-phosphate-type ester compound. The “non-phosphate-type ester compound” means an ester compound not including phosphates.

The high-molecular additive of the polycondensation polymer includes polyester polymer (aliphatic polyester polymer, aromatic polyester polymer, etc.), and copolymer of polyester ingredient and other ingredient, etc. Preferred are aliphatic polyester polymer, aromatic polyester polymer; copolymer of polyester polymer (aliphatic polyester polymer, aromatic polyester polymer, etc.) and acrylic polymer; and copolymer of polyester polymer (aliphatic polyester polymer, aromatic polyester polymer, etc.) and styrenic polymer. More preferred are polyester compounds containing an aromatic ring as at least one copolymerization ingredient.

The aliphatic polyester polymer is obtained through reaction of an aliphatic dicarboxylic acid having from 2 to 20 carbon atoms and at least one diol selected from an aliphatic diol having from 2 to 12 carbon atoms and an alkyl ether diol having from 4 to 20 carbon atoms; and both terminals of the reaction product may be as such directly after the reaction, but may be blocked through additional reaction with a monocarboxylic acid, a monoalcohol or a phenol. The terminal blocking is effective in point of the storability of the polymer, and is often attained for removing free carboxylic acids from the polymer. The dicarboxylic acid for use for the polyester polymer for use in the invention is preferably an aliphatic dicarboxylic acid residue having from 4 to 20 carbon atoms, or an aromatic dicarboxylic acid residue having from 8 to 20 carbon atoms.

The aliphatic dicarboxylic acid having from 2 to 20 carbon atoms preferred for use in the invention includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid, and 1,4-cyclohexanedicarboxylic acid.

Of those, preferred aliphatic dicarboxylic acids are malonic acid, succinic acid, maleic acid, fumaric acid, glutaric acid, adipic acid, azelaic acid and 1,4-cyclohexanedicarboxylic acid. More preferred aliphatic dicarboxylic acids are succinic acid, glutaric acid and adipic acid.

The diol for use for the high-molecular additive is, for example, selected from an aliphatic diol having from 2 to 20 carbon atoms, and an alkyl ether diol having from 4 to 20 carbon atoms.

The aliphatic diol having from 2 to 20 carbon atoms includes an alkyl diol and alicyclic diol, for example, ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One or more of these glycols may be used here either singly or as combined in a mixture thereof.

Preferred diols are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, and 1,4-cyclohexanedimethanol; and more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, and 1,4-cyclohexanedimethanol.

As the alkyl ether diol having from 4 to 20 carbon atoms, preferably mentioned are polytetramethylene ether glycol, polyethylene ether glycol and polypropylene ether glycol, and their mixtures. Not specifically defined, the mean degree of polymerization of the diol is from 2 to 20, more preferably from 2 to 10, even more preferably from 2 to 5, still more preferably from 2 to 4. As their examples, typically mentioned are commercially-available polyether glycols, Carbowax Resin, Pluronics Resin and Niax Resin.

In the invention, especially preferred is use of a high-molecular additive of which the terminals are blocked with an alkyl group or an aromatic group. In these, the terminals are protected with a hydrophobic functional group, and therefore, the additive is effective against deterioration with time in high-temperature and high-humidity environments. This is because the hydrolysis of the ester group in these is retarded.

In the invention, preferably, both terminals of the polyester additive are protected with a monoalcohol residue or a monocarboxylic acid residue so that the terminals could not be a carboxylic acid or an OH group.

In this case, as the monoalcohol, preferred is a substituted or unsubstituted monoalcohol having from 1 to 30 carbon atoms, and there may be mentioned aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; and substituted alcohols such as benzyl alcohol, 3-phenylpropanol, etc.

Alcohols preferred for use for terminal blocking include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

In case where the terminals are blocked with a monocarboxylic acid residue, the monocarboxylic acid for the monocarboxylic acid residue is preferably a substituted or unsubstituted monocarboxylic acid having from 1 to 30 carbon atoms. The acid may be an aliphatic monocarboxylic acid or an aromatic ring-containing carboxylic acid. As preferred aliphatic monocarboxylic acids, there may be mentioned acetic acid, propionic acid, butanoic acid, caprylic acid, caproic acid, decanoic acid, dodecanoic acid, stearic acid, oleic acid; and as aromatic ring-containing monocarboxylic acids, for example, there may be mentioned benzoic acid, p-tert-butylbenzoic acid, p-tert-amylbenzoic acid, ortho-toluic acid, meta-toluic acid, para-toluic acid, dimethylbenzoic acid, ethylbenzoic acid, normal-propylbenzoic acid, aminobenzoic acid, acetoxybenzoic acid, etc. One or more of these may be used here.

The high-molecular additive may be produced with ease according to ordinary methods, for example, according to a thermal melt condensation method of polyesterification reaction or interesterification reaction of the above-mentioned aliphatic dicarboxylic acid and diol and/or the monocarboxylic acid or monoalcohol for terminal blocking, or according to a method of interfacial condensation of a chloride of such an acid and a glycol. The polyester additives are described in detail by Koichi Murai in “Additives, Their Theory and Application” (by Miyuki Publishing, 1st edition of original version published on Mar. 1, 1973). Materials described in JP-A 05-155809, 05-155810, 05-197073, 2006-259494, 07-330670, 2006-342227, 2007-003679 are also usable here.

The aromatic polyester polymer can be produced through copolymerization of the above-mentioned polyester polymer with an aromatic ring-having monomer. The aromatic ring-having monomer is at least one monomer selected from aromatic dicarboxylic acids having from 8 to 20 carbon atoms, and aromatic diols having from 6 to 20 carbon atoms.

The aromatic dicarboxylic acid having from 8 to 20 carbon atoms includes phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, and 2,6-naphthalenedicarboxylic acid. Of those, preferred aromatic dicarboxylic acids are phthalic acid, terephthalic acid, and isophthalic acid.

The aromatic diol having from 6 to 20 carbon atoms includes, though not specifically defined, bisphenol A, 1,2-hydroxybenzene, 1,3-hydroxybenzene, 1,4-hydroxybenzene, 1,4-benzenedimethanol. Preferred are bisphenol A, 1,4-hydroxybenzene and 1,4-benzenedimethanol.

In the invention, the aromatic polyester polymer is used as a combination of the above-mentioned polyester with at least one of an aromatic dicarboxylic acid or an aromatic diol, and the combination is not specifically defined. Several types of the respective ingredients may be combined in any desired manner. In the invention, as described above, the high-molecular additive is preferably blocked with an alkyl group or an aromatic group at the terminals thereof, and for blocking the terminals, the above-mentioned method is employable.

### (Retardation Reducer)

As the retardation reducer in the invention, widely employable are phosphate compounds and compounds except non-phosphate compounds known as additives to cellulose acylate film.

The polymer-type retardation reducer usable herein is selected from phosphate-type polyester polymers, styrenic polymers, acrylic polymers and their copolymers; and preferred are acrylic polymers and styrenic polymers. Preferably, the film of the invention contains at least one polymer having an inherent negative birefringence, such as styrenic polymers and acrylic polymers.

The low-molecular retardation reducer that is a compound except non-phosphate compounds includes the following. These may be solid or oily. Briefly, the melting point and the boiling point of the compounds are not specifically defined. For example, there may be mentioned a mixture of UV absorbent materials in which the melting or boiling point of one material is not higher than 20° C. and that of the other is higher than 20° C., and a mixture of degradation inhibitors of the same type as above. IR absorbent dyes usable herein are described, for example, in JP-A 2001-194522. The time when the additive is added may be at any time in the cellulose acylate solution (dope) production step. As the case may be, a step of adding the additive may be additionally provided in the final stage after the dope preparation step. The amount of the material to be added is not specifically defined so far as the material can express its function.

The low-molecular retardation reducer that is a compound except non-phosphate compounds is not specifically defined, and its details are described in JP-A 2007-272177, [0066] to [0085].

The compounds represented by the general formula (1) in JP-A 2007-272177, [0066] to [0085] can be produced according to the following method.

The compound of the general formula (1) in the patent publication can be produced through condensation of a sulfonyl chloride derivative and an amine derivative.

The compound represented by the genera formula (2) in JP-A 2007-272177 can be produced through dehydrating condensation of a carboxylic acid and an amine using a condensing agent (for example, dicyclohexylcarbodiimide (DCC), etc.), or through substitution reaction of a carboxylic acid chloride derivative and an amine derivative.

The retardation reducer is preferably an Rth reducer from the viewpoint of realizing a favorable Nz factor. The Rth reducer of the retardation reducer includes acrylic polymers and styrenic polymers as well as low-molecular compounds of the general formulae (3) to (7) in the above-mentioned patent publication. Of those, preferred are acrylic polymers and styrenic polymers, and more preferred are acrylic polymers.

Preferably, the retardation reducer is added in a ratio of from 0.01 to 30% by mass relative to the cellulose resin, more preferably from 0.1 to 20% by mass, even more preferably from 0.1 to 10% by mass.

When the amount is at most 30% by mass, the compatibility of the compound with the cellulose resin can be bettered, and the formed film can be prevented from whitening. In case where two or more different types of retardation reducers are used, preferably, their total amount is within the above range.

### (Retardation Enhancer)

Preferably, the film of the invention contains at least one retardation enhancer in the above-mentioned low-substitution layer for the purpose of expressing the retardation value thereof. The retardation enhancer is not specifically defined. There may be mentioned rod-shaped or discotic compounds, as well as those of the above-mentioned non-phosphate compounds that have a retardation enhancing capability. As the rod-shaped or discotic compounds, compounds having at least two aromatic rings are preferably used herein as the retardation enhancer.

The amount to be added of the retardation enhancer of a rod-shaped compound is preferably from 0.1 to 30 parts by mass relative to 100 parts by mass of the polymer ingredient containing cellulose acylate, more preferably from 0.5 to 20 parts by mass. Preferably, the amount of the discotic compound contained in the retardation enhancer is less than 3 parts by mass relative to 100 parts by mass of the cellulose acylate, more preferably less than 2 parts by mass, even more preferably less than 1 part by mass.

Discotic compounds are superior to rod-shaped compounds in point of the Rth retardation enhancing capability thereof, and therefore the former are favorably used when an especially large Rth retardation is needed. Two or more different types of retardation enhancers may be used here as combined.

Preferably, the retardation enhancer for use herein has a maximum absorption in a wavelength region of from 250 to 400 nm, but does not have any substantial absorption in the visible region.

The details of the retardation enhancer are described in Disclosure Bulletin 2001-1745, p. 49.

### (Plasticizer)

As the plasticizer for use in the invention, many compounds known as a plasticizer for cellulose acylate are usable. For example, the plasticizer includes phosphates or carboxylates. Examples of the phosphates are triphenyl phosphate (TPP) and tricresyl phosphate (TCP). The carboxylates are typically phthalates and citrates. Examples of the phthalates are dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates are triethyl O-acetylcitrate (OACTE) and tributyl O-acetylcitrate (OACTB). Examples of the other carboxylates are butyl oleate, methylacetyl ricinoleate, dibutyl sebacate, and various types of trimellitates. Preferred is use of the phthalate plasticizer (DMP, DEP, DBP, DOP, DPP, DEHP). More preferred are DEP and DPP.

### (Antioxidant)

In the invention, a known antiaging agent (antioxidant), for example, a phenolic or hydroquinone-type antioxidant such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis (4-ethyl-6-tert-butylphenol), 2,5-di-tert-butylhydroquinone, pentaerythrityl tetrakis [3-(3,5-di-tert-butyl-4-hydroxyphenyl) propionate] or the like may be added to the cellulose acylate solution. Further, preferred is use of a phosphate-type antioxidant such as tris (4-methoxy-3,5-diphenyl) phosphite, tris(nonylphenyl) phosphite, tris (2,4-di-tert-butylphenyl) phosphite, bis(2,6-di-tert-butyl-4-methylphenyl)pentaerythritol diphosphite, bis (2,4-di-tert-butylphenyl)pentaerythritol diphosphite, etc. Preferably, the amount of the antioxidant to be added is from 0.05 to 5.0 parts by mass relative to 100 parts by mass of the cellulose resin.

### (UV Absorbent)

In the invention, a UV absorbent may be added to the cellulose acylate solution from the viewpoint of preventing the degradation of polarizer, liquid crystal, etc. As the UV absorbent, preferred are those excellent in UV absorbability at a wavelength of at most 370 nm and poorly absorbing visible light having a wavelength of 400 nm or more, from the viewpoint of securing good liquid crystal display performance. Specific examples of the UV absorbent preferred for use in the invention include, for example, hindered phenolic compounds, hydroxybenzophenone compounds, benzotriazole compounds, salicylate compounds, benzophenone compounds, cyanoacrylate compounds, nickel complex compounds, etc. Examples of the hindered phenolic compounds include 2,6-di-tert-butyl-p-cresol, pentaerythrityl tetrakis[3-(3,5-di-tert-butyl-4-hydroxyphenyl) propionate], N,N′-hexamethylenebis(3,5-di-tert-butyl-4-hydroxy-hydrocinnamide),
1,3,5-trimethyl-2,4,6-tris(3,5-di-tert-butyl-4-hydroxybenz yl)benzene, tris-(3,5-di-tert-butyl-4-hydroxybenzyl) isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol),
(2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate],
N,N′-hexamethylenebis(3,5-di-tert-butyl-4-hydroxy-hydrocin namide),
1,3,5-trimethyl-2,4,6-tris(3,5-di-tert-butyl-4-hydroxybenz yl)benzene,
2-(2′-hydroxy-3′,5′-di-tert-butylphenyl)-5-chlorobenzotriazole,
(2-(2′-hydroxy-3′,5′-di-tert-amylphenyl)-5-chlorobenzotriazole,
2,6-di-tert-butyl-p-cresol, pentaerythrityl tetrakis[3-(3,5-di-tert-butyl-4-hydroxyphenyl)propionate], etc. The amount of the UV inhibitor is preferably from 1 ppm to 1.0% by mass in the entire optical film, more preferably from 10 to 1000 ppm.

### (Mat Agent)

Preferably, at least one high-substitution layer mentioned above of the film of the invention contains a mat agent, from the viewpoint of securing film slidability and securing safe production. The mat agent may be an inorganic compound mat agent or an organic compound mat agent.

Preferred examples of the inorganic compound mat agent are silicon-containing inorganic compounds (e.g., silicon dioxide, fired calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, tin antimony oxide, calcium carbonate, talc, clay, fired kaolin, calcium phosphate, etc. More preferred are silicon-containing inorganic compounds and zirconium oxide; and even more preferred is use of silicon dioxide as capable of reducing the haze of the film of the invention. As fine particles of silicon dioxide, usable are commercially-available products of, for example, trade names of Aerosil R972, R974, R812, 200, 300, R202, OX50, TT600 (all by Nippon Aerosil), etc. As fine particles of zirconium oxide, usable are commercial products of, for example, trade names of Aerosil R976 and R811 (both by Nippon Aerosil), etc.

Preferred examples of the organic compound mat agent include, for example, polymers such as silicone resin, fluororesin, acrylic resin, etc., and more preferred is silicon resin. Of silicon resin, especially preferred are those having a three-dimensional network structure, for which, for example, usable are commercially-available products of Tospearl 103, Tospearl 105, Tospearl 108, Tospearl 120, Tospearl 145, Tospearl 3120 and Tospearl 240 (all by Toshiba Silicone), etc.

In case where the mat agent is added to the cellulose acylate solution, the method is not specifically defined, and any method capable of producing the desired cellulose acylate solution is employable with no problem. For example, the additive may be added in the stage where cellulose acylate is mixed with solvent, or the additive may be added after a mixed solution of cellulose acylate and solvent has been prepared. Further, the additive may be added and mixed just before the dope is cast, and this is a method of addition just before casting, in which a screw-type kneading mixer may be provided for on-line mixing. Concretely, a static mixer such as an in-line mixer is preferred. As the in-line mixer, for example, preferred is Static Mixer SWJ (Toray's static-type in-line mixer Hi-Mixer) (by Toray Engineering). Regarding in-line addition, JP-A 2003-053752 describes an invention of a production method for a cellulose acylate film, in which the distance (L) between the tip of the supply nozzle where an additive liquid having a different composition is added to the main material dope and the starting side of the in-line mixer is controlled to be at most 5 times the inner diameter d of the pipeline for the main material, whereby the density unevenness and the mat particles aggregation can be removed. The patent publication describes a more preferred embodiment of the invention where the distance (L) between the opening of the tip of the supply nozzle where an additive liquid having a different composition is added to the main material dope and the starting side of the in-line mixer is controlled to be at most 10 times the inner diameter (d) of the opening of the tip of the supply nozzle, and the in-line mixer is a static non-stirring in-line mixer or a dynamic stirring in-line mixer. More concretely, as illustrated in the patent publication, the flow rate of the cellulose acylate film main material dope/in-line additive liquid is from 10/1 to 500/1, preferably from 50/1 to 200/1. Further, JP-A 2003-014933 which provides an invention of a retardation film free from a problem of delamination of the constitutive layers, having good lubricity and excellent in transparency, discloses a method of adding an additive to the film. According to the method, the additive may be added to the melting tank, or the additive or a solution or dispersion of the additive may be added to the dope being fed from the melting tank to the co-casting die, and the patent publication says that, in the latter method, a static mixer or the like mixing means is preferably provided for the purpose of enhancing the mixing performance.

Unless the mat agent is added too much to the film of the invention, the haze of the film does not increase; and in fact, in a case where the film is used in LCD, the mat agent added thereto does not cause any inconveniences of contrast reduction, bright spot generation, etc. On the other hand, when the amount is too small, then the problem of film grating could not be solved and the abrasion resistance of the film could not be realized. From these viewpoints, preferably, the mat agent is added in a ratio of from 0.01 to 5.0% by weight, more preferably from 0.03 to 3.0% by weight, even more preferably from 0.05 to 1.0% by weight.

### <Film Characteristics>

### (Layer Configuration of Film)

The film of the invention may be a single layer or a laminate of two or more layers.

In case where the film of the invention is a two-layer or more multi-layer laminate, it is preferably a two-layer laminate or a three-layer laminate, more preferably a three-layer laminate. Preferably, the three-layer laminate has a layer of the film of the invention that is kept in contact with the metal support in producing the film according to a solution casting method (hereinafter this may be referred to as a support-side layer or a skin B layer), and an air interface layer opposite to the metal support (hereinafter this may be referred to as an air-side layer or a skin A layer), and one core layer sandwiched between them. Specifically, the film of the invention has a three-layer configuration of skin B layer/core layer/skin A layer.

In case where the film of the invention contains a cellulose acylate, the degree of acyl substitution of the cellulose acylate of each layer may be the same, or a plurality of cellulose acylates may be made to form one layer as mixed. In the latter case, preferably, the degree of acyl substitution of the cellulose acylate in every layer is all the same from the viewpoint of controlling the optical properties of the film. In case where the film of the invention has a three-layer configuration, preferably, the cellulose acylate contained in both surface layers of the film has the same degree of acyl substitution from the viewpoint of the production cost of the film.

### (Retardation)

Of the film of the invention, the in-plane retardation Re measured at a wavelength of 590 nm is preferably 0 nm≦Re≦200 nm, more preferably 0 nm≦Re≦150 nm, even more preferably 0 nm≦Re≦100 nm.

Of the film of the invention, the thickness-direction retardation Rth measured at a wavelength of 590 nm is preferably 0 nm≦Rth≦400 nm, more preferably 0 nm≦Rth≦300 nm, even more preferably 0 nm≦Rth≦250 nm.

Preferably, the film of the invention is a biaxial optical compensatory film.

The biaxial optical compensatory film means that nx, ny and nz of the optical compensatory film all differ from each other (where nx means the refractive index in the in-plane slow axis direction, ny means the refractive index in the in-plane direction perpendicular to nx, and nz means the refractive index in the direction perpendicular to nx and ny), and in the invention, more preferably, nx>ny>nz.

The film of the invention, which has the biaxial optical property, is preferred in that, when it is incorporated in a liquid crystal display device, especially in a VA-mode liquid crystal display device and when the device is watched in oblique directions, the device can solve the problem of color shift.

In this description, Re (λ) and Rth (λ) each mean the in-plane retardation and the thickness-direction retardation, respectively, of a film at a wavelength of λ. Unless otherwise specifically indicated in this description, the wavelength λ is 590 nm. Re(λ) is measured by applying a light having a wavelength of λ nm to a film sample in the normal direction of the film, using KOBRA 21ADH (by Oji Scientific Instruments). Rth (λ) is determined as follows: With the in-plane slow axis (determined by KOBRA 21ADH) taken as the tilt axis (rotation axis) of the film (in case where the film has no slow axis, the rotation axis of the film may be in any in-plane direction of the film), Re (λ) of the film is measured at 6 points in all thereof, from the normal direction of the film up to 50 degrees on one side relative to the normal direction thereof at intervals of 10°, by applying a light having a wavelength of λ nm from the tilted direction of the film. Based on the thus-determined retardation data, the assumptive mean refractive index and the inputted film thickness, Rth(λ) of the film is computed with KOBRA 21ADH. Apart from this, Re (λ) may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (A) and (B). In this, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethylmethacrylate (1.49), polystyrene (1.59). With the assumptive mean refractive index and the film thickness inputted thereinto, KOBRA 21ADH can compute nx, ny and nz. From the thus-computed data nx, ny and nz, Nz=(nx−nz)/(nx−ny) is induced.

$$\begin{matrix}[ Numerical formula 1 ] & \\ Re ( θ ) = [ nx - \frac{ny \times nz}{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} ] \times \frac{d}{cos \{ {sin}^{- 1} ( \frac{sin ( - θ )}{nx} ) \}} & ( A )\end{matrix}$$

In this, Re (θ) means the retardation of the film in the direction tilted by an angle θ from the normal direction to the film; nx, ny and nz each mean the refractive index in each main axis direction of an index ellipsoid; and d means the thickness of the film.

Rth=((nx+ny)/2−nz)×d (B)

In this, the mean refractive index n is needed as the parameter, for which used are the data measured with an Abbe's refractiometer (Atago's “Abbe Refractiometer 2-T”).

### (Film Thickness)

Preferably, the mean thickness of the low-substitution layer in the film of the invention is from 30 to 100 μm, more preferably from 30 to 80 μm, even more preferably from 30 to 70 μm. The film in which the thickness of the layer is at least 30 μm is preferred since the handleability in producing the web of the film is better; and the film in which the thickness of the layer is at most 70 μm is also preferred since the film is resistant to environmental humidity change and well maintains the optical characteristics thereof.

In case where the film of the invention has a laminate structure of three or more layers, preferably, the thickness of the core layer is from 30 to 70 μm, more preferably from 30 to 60 μm, even more preferably from 30 to 50 μm. In case where the film of the invention has a laminate structure of three or more layers, preferably, the thickness of the surface layer of both sides of the film (skin layer A and skin layer B) is from 0.5 to 20 μm, more preferably from 0.5 to 10 μm, even more preferably from 0.5 to 3 μm.

### (Film Width)

Preferably, the width of the film of the invention is from 700 to 3000 mm, more preferably from 1000 to 2800 mm, even more preferably from 1500 to 2500 mm.

### [Resin Film Production Method]

The production method for the resin film of the invention (hereinafter this may be referred to as the production method of the invention) comprises a step of casting a dope that contains a resin and from 0.01% by mass to 20% by mass, relative to the resin, of an organic acid satisfying the following requirements (1) to (3), onto a metal support to form a dope film thereon, and a step of peeling the dope film from the metal support:

(1) The compound contains a structure of a polyalcohol and a polycarboxylic acid forming an ester bond and bonding to each other via the bond therein,
(2) The total number of the molecules of the polyalcohol and the polycarboxylic acid forming the compound is at least 3,
(3) The compound has at least one unsubstituted carboxylic acid derived from the polycarboxylic acid.

The production method of the invention is described in detail hereinunder.

Preferably, the resin film of the invention is produced according to a solvent casting method. For production examples of the resin film of the invention according to a solvent casting method, referred to are U.S. Pat. Nos. 2,336,310, 2,367,603, 2,492,078, 2,492,977, 2,492,978, 2,607,704, 2,739,069, 2,739,070; British Patent 640731, 736892; JP-B 45-4554, 49-5614; JP-A 60-176834, 60-203430, 62-115035, etc.

The resin film of the invention may be stretched. For the method of stretching treatment and the condition thereof, referred to are, for example, JP-A 62-115035, 4-152125, 4-284211, 4-298310, 11-48271, etc.

### <Casting Method>

The solution casting method includes a method of extruding a prepared dope uniformly onto a metal support through a pressure die; a doctor blade method in which the dope once cast onto a metal support is leveled with a blade to control the thickness of the formed film; a method of using a reverse roll coater in which the film thickness is controlled by the reversely-rotating roll, etc. Preferred is the method of using a pressure die. The pressure die includes a coat-hanger type die, a T-die, etc., any of which is favorably usable here. Apart from the methods described herein, any other various types of known methods for producing films by casting cellulose triacetate solution are employable here. In consideration of the difference in the boiling point of the solvents used, the casting condition may be settled, and the same effects as those described in the related patent publications can also be obtained here.

### [Co-Casting]

In producing the film of the invention, preferably used is a lamination casting method such as a co-casting method, a successive casting method, a coating method, etc. More preferred is a simultaneous co-casting method from the viewpoint of stable production and production cost reduction.

In case where the film is produced according to a co-casting method or a successive casting method, first prepared is the cellulose acetate solution (dope) for each layer. In the co-casting method (multilayer simultaneous casting method), co-casting dopes for the constituent layers (three layers or more) are simultaneously extruded out through a co-casting die (hereinafter this may be referred to as a die or a casting Giesser) via different slits onto a support, and at a suitable time, the film formed on the support is peeled away and dried. FIG. 2 is a cross-sectional view showing a mode of simultaneous extrusion to form three layers by casting the dope 1A for support-facing surface layer, the dope 2 for core layer and the dope 1B for air-facing surface layer on a casting support 4 through a co-casting die 3.

The successive-casting method is as follows: First the dope for the first layer is extruded out and cast onto a casting support through a casting die, then after it is dried or not dried, the casting dope for the second layer is cast onto it in a mode of extrusion through a casting die, and if desired, three or more layers are successively formed in the same mode of casting and lamination, and at a suitable time, the resulting laminate film is peeled away from the support and dried. The coating method is generally as follows: A film of a core layer is formed according to a solution casting method, then a coating solution for surface layer is prepared, and using a suitable coater, the coating solution is applied onto the previously formed core film first on one surface thereof and next on the other surface thereof, or simultaneously on both surfaces thereof, and the resulting laminate film is dried.

In the resin film of the invention, preferably, the organic film satisfying the requirements (1) to (3) is eccentrically located on one film surface side from the viewpoint of improving the peelability of the film and enhancing the polarizer durability with the film. As the method of eccentrically locating the organic film satisfying the requirements (1) to (3) on one film surface side, preferably employed here is a method of adding the organic acid satisfying the requirements (1) to (3) to only the casting solution for a specific layer in the lamination casting method.

Specifically, in case where the organic film satisfying the requirements (1) to (3) is eccentrically located on one film surface side, in the production method of the invention where dopes for at least two layers are co-cast onto a metal support, the organic acid satisfying the requirements (1) to (3) may be added to the dope for the layer to face the metal support side and/or to the dope for the layer to face the air interface side, but preferably, the organic acid satisfying the requirements (1) to (3) is added to only one of the dope for the layer to face the metal support side or the dope for the layer to face the air interface side.

As the endlessly running metal support for use in producing the film of the invention, usable is a drum of which the surface is mirror-finished by chromium plating, or a stainless belt (band) of which the surface is mirror-finished by polishing. One or more pressure dies may be arranged above the metal support. Preferably, one or two pressure dies are arranged. In case where two or more pressure dies are arranged, the dope to be cast may be divided into portions suitable for the individual dies; or the dope may be fed to the die at a suitable proportion via a plurality of precision metering gear pumps. The temperature of the dope (resin solution) to be cast is preferably from −10 to 55° C., more preferably from 25 to 50° C. In this case, the solution temperature may be the same throughout the entire process, or may differ in different sites of the process. In case where the temperature differs in different sites, the dope shall have the desired temperature just before cast.

The material of the metal support is not specifically defined. Preferably, the metal support is formed of SUS (for example, SUS 316).

### <Stretching Treatment>

The production method of the invention preferably includes a step of stretching the formed film. As described above, the optical compensatory film of the invention is characterized by having improved wavelength dispersion characteristics; and the stretching treatment makes it possible to impart the optical performance to the film, and further makes it possible to give a desired retardation to the resin film of the invention. The stretching direction of the resin film of the invention may be preferably any of the machine direction or the direction perpendicular to the machine direction (cross direction). More preferably, the film is stretched in the direction perpendicular to the machine direction (cross direction) from the viewpoint of the subsequent process of using the film for producing a polarizer.

The method of stretching in the cross direction is described, for example, in JP-A 62-115035, 4-152125, 4-284211, 4-298310, 11-48271, etc. For the machine-direction stretching, for example, the speed of the film conveyor rollers is regulated so that the film winding speed could be higher than the film peeling speed whereby the film may be stretched. For the cross-direction stretching, the film is conveyed while held by a tenter on the sides thereof and the tenter width is gradually broadened, whereby the film can be stretched. After dried, the film may be stretched with a stretcher (preferably for monoaxial stretching with a long stretcher).

Preferably, the draw ratio in stretching the film of the invention is from 5% to 200%, more preferably from 10% to 100%, even more preferably from 20% to 50%.

In case where the resin film of the invention is used as a protective film for a polarizing element, the transmission axis of the polarizing element must be in parallel to the in-plane slow axis of the resin film of the invention so as to prevent the light leakage in oblique directions to the polarizer. The transmission axis of the roll film-type polarizing element that is produced continuously is generally parallel to the cross direction of the roll film, and therefore, in continuously sticking the roll film-type polarizing element and a protective film comprising the roll film-type resin film of the invention, the in-plane slow axis of the roll film-type protective film must be parallel to the cross direction of the film. Accordingly, the film is preferably stretched to a larger extent in the cross direction. The stretching treatment may be attained during the course of the film formation process, or the wound film may be unwound and stretched. In the production method of the invention, the film is stretched while it contains a residual solvent therein, and consequently, it is desirable that the film is stretched during the course of the film formation process.

### <Drying>

Preferably, the production method of the invention includes a step of drying the resin film and a step of stretching the dried resin film at a temperature not lower than (Tg−10° C.), from the viewpoint of enhancing the retardation of the film.

For drying the dope on a metal support in production of the resin film of the invention, generally employable is a method of applying hot air to the surface of the metal support (drum or belt), or that is, onto the surface of the web on the metal support; a method of applying hot air to the back of the drum or belt; or a back side liquid heat transfer method that comprises contacting a temperature-controlled liquid with the opposite side of the dope-cast surface of the belt or drum, or that is, the back of the belt or drum to thereby heat the belt or drum by heat transmission to control the surface temperature thereof. Preferred is the backside liquid heat transfer method. Preferred is the back side liquid heat transfer method. The surface temperature of the metal support before the dope is cast thereon may be any degree so far as it is not higher than the boiling point of the solvent used in the dope. However, for promoting the drying or for making the dope lose its flowability on the metal support, preferably, the temperature is set to be lower by from 1 to 10° C. than the boiling point of the solvent having the lowest boiling point of all the solvents in the dope. In case where the cast dope is peeled off after cooled but not dried, then this shall not apply to the case.

### <Peeling>

The production method of the invention preferably includes a step of peeling the dope film from the metal support. The peeling method in the production method of the invention is not specifically defined. Any known method is employable here for enhancing the peelability of the film.

For controlling the thickness of the film, the solid concentration in the dope, the slit gap of the die nozzle, the extrusion pressure from the die, and the metal support speed may be suitably regulated so that the formed film could have a desired thickness.

Produced in the manner as above, the length of the resin film of the invention to be wound up is preferably from 100 to 10000 m per roll, more preferably from 500 to 7000 m, even more preferably from 1000 to 6000 m. In winding the film, preferably, at least one side thereof is knurled, and the knurling width is preferably from 3 mm to 50 mm, more preferably from 5 mm to 30 mm, and the knurling height is preferably from 0.5 to 500 μm, more preferably from 1 to 200 μm. This may be one-way or double-way knurling.

In general, in large-panel display devices, contrast reduction and color shift may be remarkable in oblique directions; and therefore the resin film of the invention is especially suitable for use in large-panel display devices. In case where the film of the invention is used as an optical compensatory film for large-panel liquid crystal display devices, for example, the film is shaped preferably to have a width of at least 1470 mm. The optical compensatory film of the invention includes not only film sheets cut to have a size that may be directly incorporated in liquid crystal display devices but also long films continuously produced and rolled up into rolls. The optical compensatory film of the latter embodiment is stored and transported in the rolled form, and is cut into a desired size when it is actually incorporated into a liquid crystal display device or when it is stuck to a polarizing element or the like. The long film may be stuck to a polarizing element formed of a long polyvinyl alcohol film directly as it is long, and then when this is actually incorporated into a liquid crystal display device, it may be cut into a desired size. One embodiment of the long optical compensatory film rolled up into a roll may have a length of 2500 m/roll or more.

### [Polarizer]

The invention also relates to a polarizer comprising at least one film of the invention.

Preferably, the polarizer of the invention comprises a polarizing element and the film of the invention on one face of the polarizing element. Like that of the optical compensatory film of the invention, the embodiment of the polarizer of the invention may include not only polarizers in the form of film sheets cut to have a size that may be directly incorporated in liquid crystal display devices but also polarizers in the form of long films continuously produced and rolled up into rolls (for example having a length of at least 2500 m/roll or at least 3900 m/roll). For use in large-panel liquid crystal display devices, the width of the polarizer is preferably at least 1470 mm as so mentioned in the above.

The concrete constitution of the polarizer of the invention is not specifically defined, for which, therefore, any known constitution is employable. For example, the constitution of FIG. 6 in JP-A 2008-262161 is employable here.

### [Liquid Crystal Display Device]

The invention also relates to a liquid crystal display device comprising the polarizer of the invention.

The liquid crystal display device of the invention is a liquid crystal display device, preferably an IPS, OCB or VA-mode liquid crystal display device comprising a liquid crystal cell and a pair of polarizers arranged on both sides of the liquid crystal cell, in which at least one of the polarizers is the polarizer of the invention.

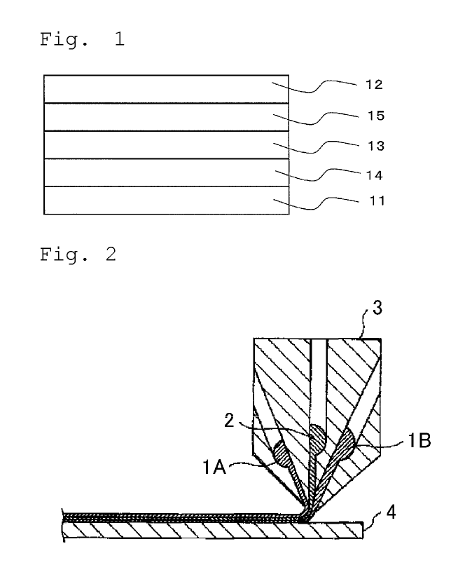

As the concrete constitution of the liquid crystal display device of the invention, any known constitution is employable without particular limitation, and the constitution shown in FIG. 1, for example, is employable. The constitution of FIG. 2 in JP-A 2008-262161 is also preferably employable herein.

### EXAMPLES

The invention is described more concretely with reference to the following Examples. In the following Examples, the materials, the reagents and the substances used, their amount and ratio, the details of the treatment and the treatment process may be suitably modified or changed not overstepping the spirit and the scope of the invention. Accordingly, the invention should not be limitatively interpreted by the Examples mentioned below.

### Example 101

### Formation of Polarizer Protective Film

### (Preparation of Cellulose Acylate Solution)

The following composition was put into a mixing tank and stirred to dissolve the ingredients, thereby preparing a cellulose acylate solution 1.

Composition of Cellulose Acylate Solution 1

| | |
|---|---|
| Cellulose acetate having a degree of acetyl substitution of | 100.0 mas. pts. |
| 2.45 and a degree of polymerization of 370 | |
| Polycondensate polyester A having a weight-average | 17.0 mas. pts. |
| molecular weight of 1200 | |
| Methylene chloride (first solvent) | 402.0 mas. pts. |
| Methanol (second solvent) | 60.0 mas. pts. |

[Chemical Formula 1]
Polycondensate Polyester A:

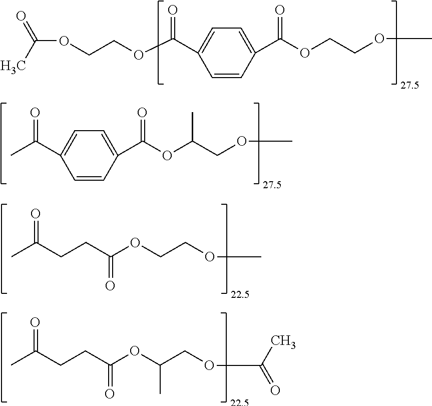

### (Preparation of Mat Agent Solution 2)

The following composition was put into a mixing tank and stirred to dissolve the ingredients, thereby preparing a mat agent solution 2.

Composition of Mat Agent Solution 2

| | |
|---|---|
| Silica particles having a mean particle size of 20 nm | 2.0 mas. pts. |
| (AEROSIL R972, by Nippon Aerosil) | |
| Methylene chloride (first solvent) | 75.0 mas. pts. |
| Methanol (second solvent) | 12.7 mas. pts. |
| Cellulose acylate solution 1 mentioned above | 10.3 mas. pts. |

### (Preparation of Organic Acid Solution 3)

The following composition was put into a mixing tank and stirred under heat to dissolve the ingredients, thereby preparing an organic acid solution 3.

Composition of Organic Acid Solution 3

| | |
|---|---|
| Organic Acid Condensate A-2 | 20.0 mas. pts. |
| Methylene chloride (first solvent) | 67.2 mas. pts. |
| Methanol (second solvent) | 10.0 mas. pts. |
| Cellulose acylate solution 1 mentioned above | 12.8 mas. pts. |

1.3 parts by mass of the mat agent solution 2 and 0.4 parts by mass of the organic acid solution 3 were, both after filtered separately, mixed using an in-line mixer, and 98.3 parts by mass of the cellulose acylate solution 1 was added thereto and further mixed with the in-line mixer. Thus mixed, the resulting solution was cast on a band caster, dried at 100° C. so that the residual solvent content could reach 40%, and then the film was peeled. Using a tenter stretcher in an atmosphere at 150° C., the peeled film was stretched in the direction perpendicular to the machine direction at a draw ratio of 30%. Further, the stretched film was dried at 140° C. for 20 minutes. Thus produced, the thickness of the polarizer protective film of Example 101 was 55 μm.

### [Measurement of Re and Rth]

A sample of the polarizer protective film of Example 101 produced in the above was conditioned at 25° C. and at a relative humidity of 60% for at least 2 hours, and then analyzed to determine the Re value and the Rth value thereof at a wavelength of 590 nm at 25° C. and at a relative humidity 60%, using a birefringence meter (KOBRA 21ADH, by Oji Instruments).

The results are shown in Table 5 below. In the Table, the minus Re value means that the film has a slow axis in MD (machine direction).

### [Saponification Treatment of Polarizer Protective Film]

The polarizer protective film of Example 101 produced in the above was immersed in an aqueous solution of 2.3 mol/L sodium hydroxide at 55° C. for 3 minutes. This was washed in a water-washing bath at room temperature, and then neutralized with 0.05 mol/L sulfuric acid at 30° C. Again this was washed in a water-washing bath at room temperature and then dried with hot air at 100° C. Accordingly, the surface of the polarizer protective film of Example 101 was saponified.

### [Production of Polarizer]

A stretched polyvinyl alcohol film was made to adsorb iodine to prepare a polarizing element.

Using a polyvinyl alcohol adhesive, the saponified polarizer protective film of Example 101 was stuck to one side of the polarizing element. A commercially-available cellulose triacetate film (Fujitac TD80UF by FUJIFILM) was saponified in the same manner as above, and using a polyvinyl alcohol adhesive, the thus-saponified cellulose triacetate film was stuck to the other side of the polarizing element to which the polarizer protective film of Example 101 had been stuck.

In this, the polarizing element and the polarizer protective film of Example 101 were so arranged that the transmission axis of the former could be parallel to the slow axis of the latter. In addition, the polarizing element and the commercially-available triacetate film were also so arranged that the transmission axis of the former could be perpendicular to the slow axis of the latter.

In that manner, a polarizer of Example 101 was produced.

### Examples 102 to 117 and Comparative Examples 201 to 205

### Production of Polarizer Protective Films of Examples 102 to 117 and Comparative Examples 201 to 205

Polarizer films of Examples 102 to 117 and Comparative Examples 201 to 205 were produced in the same manner as in Example 101 except that the degree of substitution of the cellulose acylate, the amount of the polycondensate polyester A, the type and the amount of the organic acid, and the film thickness were changed as in Table 5 below.

In Table 5 below, the amount of the organic acid is in terms of part by mass relative to 100 parts by mass of the cellulose acylate resin. Citric acid used in Comparative Example 201 is the exemplary compound shown in Japanese Patent 4136054, and the effect of the compound in the patent reference was followed up here.

### [Saponification Treatment of Polarizer Protective Film, and Production of Polarizer]

In the same manner as in Example 101, the polarizer protective films of Examples 102 to 117 and the polarizer protective films of Comparative Examples 201 to 205 were saponified and used for polarizer production, thereby producing polarizers of the respective Examples and Comparative Examples.

### (Evaluation of Polarizer Durability)

The cross transmittance of the polarizing element at a wavelength of 410 nm of the polarizer of Examples and Comparative Examples produced in the above was measured according to the method described herein.

Subsequently, the polarizer was stored in an environment at 60° C. and at a relative humidity of 95% for 300 hours, and then in the same manner as above, the cross transmittance thereof was measured also in the same manner as above. The cross transmittance change of each sample before and after aging was determined, and this is the polarizer durability of the sample. The results are shown in Table 5. The relative humidity in the environment with no conditioning was within a range of from 0% to 20%.

(Evaluation of Corrosion with Organic Acid)

20 g of the organic acid solution prepared in Example 101 was put in an autoclave, and a sample piece of SUS316 having a size of 2 cm width×3 cm length and a thickness of 0.5 cm was immersed therein. The autoclave was closed and aged at 90° C. for 72 hours. With that, the autoclave was opened, and the test piece of SUS316 was checked for corrosion and the organic acid solution was also checked for change owing to the corrosion. According to the criteria mentioned below, the organic acid was evaluated for SUS corrosion.

1: The surface smoothness of the test piece did not change, and the organic acid solution was colorless transparent.
2: The surface smoothness of the test piece changed only a little, but the organic acid solution colored in yellow.
3: The surface of the test piece roughened, and the organic acid solution changed in brownish red and cloudy.

### (Peelability Evaluation)

The dope that had been in-line mixed in Example 101 was cast on a smooth stainless steel plate (support) to a thickness of 1 mm or so, then left as such at room temperature for 4 minutes, and checked and evaluated for the peelability thereof from the support according to the criteria mentioned below.

1: The film was peeled smoothly with no resistance, and the film surface was flat and smooth.
2: The film was peeled smoothly with some resistance, and the film surface was flat and smooth.
3: As the peeling resistance was great, the film could not be peeled smoothly; or a film residue remained on the stainless steel plate.

The evaluation results are shown in Table 5 below.

In Table 5, c) means that the cellulose acylate was prepared according to the method described in US2009/0096962A.

TABLE 5

| | Cellulose Acylate | | | | Acrylic Resin | Polycondensate | Organic Acid | |
|---|---|---|---|---|---|---|---|---|
| | degree of | degree of | total degree | amount | amount | Polyester A | | amount |
| | acetyl | propionyl | of acyl | added | added | amount added | | added |
| | substitution | substitution | substitution | (mas. pt.) | (mas. pt.) | (mas. pt.) | compound | (mas. pt.) |
| Example 101 | 2.45 | 0.00 | 2.45 | 100 | 0 | 17 | Condensate A-2 | 0.2 |
| Example 102 | 2.45 | 0.00 | 2.45 | 100 | 0 | 17 | Condensate A-2 | 0.5 |
| Example 103 | 2.45 | 0.00 | 2.45 | 100 | 0 | 17 | Condensate A-2 | 0.9 |
| Example 104 | 2.45 | 0.00 | 2.45 | 100 | 0 | 17 | Condensate A-2 | 1.5 |
| Example 105 | 2.45 | 0.00 | 2.45 | 100 | 0 | 17 | Condensate A-4 | 0.5 |
| Example 106 | 2.45 | 0.00 | 2.45 | 100 | 0 | 17 | Condensate A-6 | 1.5 |
| Example 107 | 2.45 | 0.00 | 2.45 | 100 | 0 | 17 | Condensate B-2 | 1.5 |
| Example 108 | 2.45 | 0.00 | 2.45 | 100 | 0 | 17 | Condensate C-2 | 1.5 |
| Example 109 | 2.45 | 0.00 | 2.45 | 100 | 0 | 17 | Condensate D-2 | 1.5 |
| Comparative | 2.45 | 0.00 | 2.45 | 100 | 0 | 17 | citric acid | 1.5 |
| Example 201 | | | | | | | | |
| Comparative | 2.45 | 0.00 | 2.45 | 100 | 0 | 17 | none | 0.0 |
| Example 202 | | | | | | | | |
| Comparative | 2.45 | 0.00 | 2.45 | 100 | 0 | 17 | tributyl citrate | 1.5 |
| Example 203 | | | | | | | | |
| Example 110 | 1.60 | 0.80 | 2.40 | 100 | 0 | 8 | Condensate A-2 | 2.0 |
| Example 111 | 1.60 | 0.80 | 2.40 | 100 | 0 | 8 | Condensate A-4 | 2.0 |
| Example 112 | 1.60 | 0.80 | 2.40 | 100 | 0 | 8 | Condensate A-6 | 2.0 |
| Comparative | 1.60 | 0.80 | 2.40 | 100 | 0 | 8 | none | 0.0 |
| Example 204 | | | | | | | | |
| Example 113 | 0.17^{c)} | 1.54^{c)} | 1.71^{c)} | 100 | 0 | 0 | Condensate A-2 | 1.7 |
| Example 114 | 0.17^{c)} | 1.54^{c)} | 1.71^{c)} | 100 | 0 | 0 | Condensate A-4 | 1.7 |
| Example 115 | 0.17^{c)} | 1.54^{c)} | 1.71^{c)} | 100 | 0 | 0 | Condensate A-6 | 1.7 |
| Comparative | 0.17^{c)} | 1.54^{c)} | 1.71^{c)} | 100 | 0 | 0 | none | 0.0 |
| Example 205 | | | | | | | | |
| Example 116 | 0.06^{c)} | 2.42^{c)} | 2.48^{c)} | 100 | 0 | 0 | Condensate A-2 | 1.7 |
| Example 117 | 0.11^{c)} | 1.86^{c)} | 1.97^{c)} | 100 | 0 | 0 | Condensate A-2 | 1.7 |

| | | | | Polarizer Durability: cross | | |
|---|---|---|---|---|---|---|
| | Film Characteristics | | | transmittance change (%) | | |
| | thickness | Re | Rth | 60° C., relative humidity | SUS | |
| | (μm) | [nm] | [nm] | 95%, 500 hours | Corrosion | Peelability |
| Example 101 | 55 | 54 | 126 | 0.40 | 1 | 2 |
| Example 102 | 55 | 54 | 125 | 0.32 | 1 | 1 |
| Example 103 | 55 | 54 | 124 | 0.22 | 1 | 1 |
| Example 104 | 55 | 52 | 121 | 0.14 | 1 | 1 |
| Example 105 | 55 | 53 | 123 | 0.18 | 1 | 1 |
| Example 106 | 55 | 53 | 123 | 0.16 | 1 | 1 |
| Example 107 | 55 | 52 | 123 | 0.18 | 2 | 2 |
| Example 108 | 55 | 53 | 122 | 0.14 | 1 | 1 |
| Example 109 | 55 | 52 | 123 | 0.14 | 1 | 1 |
| Comparative | 55 | 54 | 125 | 0.18 | 3 | 2 |
| Example 201 | | | | | | |
| Comparative | 55 | 54 | 127 | 0.46 | 2 | 3 |
| Example 202 | | | | | | |
| Comparative | 55 | 53 | 123 | 0.47 | 2 | 3 |
| Example 203 | | | | | | |
| Example 110 | 40 | 50 | 120 | 0.10 | 1 | 1 |
| Example 111 | 40 | 50 | 118 | 0.12 | 1 | 1 |
| Example 112 | 40 | 49 | 118 | 0.12 | 1 | 1 |
| Comparative | 40 | 51 | 121 | 0.42 | 2 | 3 |
| Example 204 | | | | | | |
| Example 113 | 65 | 60 | 200 | 0.35 | 1 | 1 |
| Example 114 | 65 | 58 | 195 | 0.36 | 1 | 1 |
| Example 115 | 65 | 59 | 205 | 0.33 | 1 | 1 |
| Comparative | 65 | 65 | 214 | 0.84 | 2 | 3 |
| Example 205 | | | | | | |
| Example 116 | 75 | 58 | 170 | 0.33 | 1 | 1 |
| Example 117 | 50 | 53 | 129 | 0.39 | 1 | 1 |

From the results in the above Table 5, it is known that the polarizer using the polarizer protective film of the invention is good as free from the trouble of degradation of the polarizer after aged in high-temperature high-humidity environments. In addition, the resin film of the invention that contains the organic acid satisfying the requirements (1) to (3) has good peelability and the organic acid used therein does not corrode SUS, and it is known that the resin film of the invention is favorable from the viewpoint of producibility.

### Example 301

### Production of Liquid crystal Display Device

Two polarizers were peeled away from a commercially-available liquid crystal television (SONY's Bravia J5000), and, using an adhesive, the polarizer of the invention having the polarizer protective film of Example 101 was stuck to the viewers' side and the backlight side of the device each one onto each side in such a manner that the polarizer protective film of Example 101 in those polarizers could face the liquid crystal cell. These were arranged in a cross Nicol configuration of such that the transmission axis of the viewers' side polarizer was in the vertical direction and the transmission axis of the backlight side polarizer was in horizontal direction. Thus constructed, the liquid crystal display device of the invention was better than the commercially-available liquid crystal television in that the contrast change and the color shift of the former in oblique directions in different ambient humidity were both small and that even after long-term use in high-temperature high-humidity environments, the contrast reduction in the former was small.

### Example 401

### Preparation of Cellulose Acylate

A cellulose acylate was produced according to the method described in JP-A 10-45804 and 08-231761, and the degree of substitution thereof was measured. Concretely, as a catalyst, sulfuric acid (7.8 parts by mass relative to 100 parts by mass of cellulose) was added to cellulose, and a carboxylic acid to be the starting material for the acyl substituent was added thereto for acylation at 40° C. In this step, the type and the amount of the carboxylic acid were changed to control the type of the acyl group and the degree of acyl substitution. After the acylation, the system was ripened at 40° C. Further, the cellulose acylate was washed with acetone to remove the low-molecular fraction therefrom.

### (Preparation of Cellulose Acylate Solution C01 for Low-Substitution Layer)

The following composition was put into a mixing tank and stirred to dissolve the ingredients, thereby preparing a cellulose acylate solution having a solid concentration of 22% by mass. The viscosity of the cellulose acylate solution was 60 Pa·s.

| | | |
|---|---|---|
| Cellulose acetate (degree of substitution 2.45) | 100.0 | mas. pts. |
| Polycondensate polyester D | 19.0 | mas. pts. |
| Organic acid condensate A-2 | 3.0 | mas. pts. |
| Methylene chloride | 365.5 | mas. pts. |
| Methanol | 54.6 | mas. pts. |

The polycondensate polyester D is terephthalic acid/succinic acid/propylene glycol/ethylene glycol copolymer (copolymerization ratio [mol %]=27.5/22.5/25/25).

### (Preparation of Cellulose Acylate Solution S01 for High-Substitution Layer)

The following composition was put into a mixing tank and stirred to dissolve the ingredients, thereby preparing a cellulose acylate solution. The amount of the solvent (methylene chloride and methanol) was suitably controlled so that the solid concentration of the solution could be 20.0% by mass.

| | | |
|---|---|---|
| Cellulose acetate (degree of substitution 2.79) | 100.0 | mas. pts. |
| Polycondensate polyester D | 19.0 | mas. pts. |
| Silica fine particles R972 (by Nippon Aerosil) | 0.15 | mas. pts. |
| Methylene chloride | 395.0 | mas. pts. |
| Methanol | 59.0 | mas. pts. |

Thus prepared, the solid concentration of the cellulose acylate solution S01 for high-substitution layer was 20.0% by mass, and the viscosity thereof was 30 Pa·s.

### (Production of Polarizer Protective Film 401)

The above cellulose acylate solutions were cast in such a manner that the cellulose acylate solution C01 for low-substitution layer could form a core layer having a thickness of 56 μm and the cellulose acylate solution S01 for high-substitution layer could form a skin A layer (air interface-side outermost layer) and a skin B layer (metal support-side outermost layer) each having a thickness of 2 μm. The formed web (film) was peeled from the bank, clipped, and while the residual solvent amount relative to the mass of the entire film was from 20 to 5%, this was laterally stretched by 1.08 times at 140° C., using a tenter. Subsequently, the film was unclipped and dried at 130° C. for 20 minutes, and then, again using a tenter, this was further laterally stretched by 1.2 times at 180° C., thereby producing a polarizer protective film 401 of the invention.

The residual solvent amount was determined according to the following formula.

Residual Solvent Amount(% by mass)={(M−N)/N}×100,

wherein M indicates the mass of the web at an arbitrary time, and N indicates the mass of the same web after dried at 120° C. for 2 hours.

### Example 402

### Preparation of Cellulose Acylate Solution C02 for Low-Substitution Layer

The following composition was put into a mixing tank and stirred to dissolve the ingredients, thereby preparing a cellulose acylate solution having a solid concentration of 22% by mass. The viscosity of the cellulose acylate solution was 60 Pa·s.

| | |
|---|---|
| Cellulose acetate (degree of substitution 2.45) | 100.0 mas. pts. |
| Polycondensate polyester D | 19.0 mas. pts. |
| Organic acid condensate A-3 | 3.0 mas. pts. |
| Compound (I-2) | 2.0 mas. pts. |
| Methylene chloride | 365.5 mas. pts. |
| Methanol | 54.6 mas. pts. |

The above compound (I-2) is a compound having the following structure:
[Chemical Formula 2]
Compound (I-2)

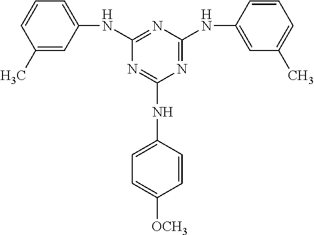 [SMILES: COc1ccc(Nc2nc(Nc3cccc(C)c3)nc(Nc3cccc(C)c3)n2)cc1]

### (Preparation of Cellulose Acylate Solution S02 for High-Substitution Layer)

The following composition was put into a mixing tank and stirred to dissolve the ingredients, thereby preparing a cellulose acylate solution. The amount of the solvent (methylene chloride and methanol) was suitably controlled so that the solid concentration of the solution could be 19.7% by mass.

| | | |
|---|---|---|
| Cellulose acetate (degree of substitution 2.79) | 100.0 | mas. pts. |
| Polycondensate polyester D | 11.0 | mas. pts. |
| Silica fine particles R972 (by Nippon Aerosil) | 0.15 | mas. pts. |
| Methylene chloride | 395.0 | mas. pts. |
| Methanol | 59.0 | mas. pts. |

Thus prepared, the solid concentration of the cellulose acylate solution S02 for high-substitution layer was 19.7% by mass, and the viscosity thereof was 40 Pa·s.

### (Production of Cellulose Acylate Sample)

The above cellulose acylate solutions were cast in such a manner that the cellulose acylate solution C02 for low-substitution layer could form a core layer having a thickness of 56 μm and the cellulose acylate solution S02 for high-substitution layer could form a skin A layer and a skin B layer each having a thickness of 2 μm. The formed web (film) was peeled from the bank, clipped, and while the residual solvent amount relative to the mass of the entire film was from 20 to 5%, this was laterally stretched by 1.08 times at 140° C., using a tenter. Subsequently, the film was unclipped and dried at 130° C. for 20 minutes, and then, again using a tenter, this was further laterally stretched by 1.2 times at 180° C., thereby producing a polarizer protective film 402 of the invention.

The residual solvent amount was determined according to the following formula.

Residual Solvent Amount(% by mass)={(M−N)/N}×100,

wherein M indicates the mass of the web at an arbitrary time, and N indicates the mass of the same web after dried at 120° C. for 2 hours.

### Example 403

A polarizer protective film 403 of the invention was produced in the same manner as in Example 402, except that the compound I-2 to be added to the cellulose acylate solution for low-substitution layer was changed to a compound I-1.

### Examples 501 to 503

### Production of Liquid Crystal Display Device

Thus produced, the polarizer protective film of Examples 401 to 403 was saponified in the same manner as in Example 101, and used for polarizer production like that for Polarizer 101. Further, in the same manner as in Example 301, the polarizer protective films of a commercially-available liquid crystal television were changed to the polarizer protective films of Examples 401 to 403 to construct liquid crystal display devices of Examples 501 to 503. The liquid crystal display devices of Examples 501 to 503 were better than the commercially-available liquid crystal television in that the contrast change and the color shift of the former in oblique directions in different ambient humidity were both small and that even after long-term use in high-temperature high-humidity environments, the contrast reduction in the former was small.

### Example 601

### Production of Polarizer Protective Film

### <Preparation of Dope 601 for Support-Side Surface Layer>

### (Preparation of Cellulose Acylate Solution)

The following composition was put into a mixing tank and stirred to dissolve the ingredients, thereby preparing a cellulose acylate solution 601.

Composition of Cellulose Acylate Solution 601

| | |
|---|---|
| Cellulose acetate having a degree of acetyl substitution of | 100.0 mas. pts. |
| 2.45 and a degree of polymerization of 370 | |
| Polycondensate polyester G having a weight-average | 17.0 mas. pts. |
| molecular weight of 1200 | |
| Methylene chloride (first solvent) | 402.0 mas. pts. |
| Methanol (second solvent) | 60.0 mas. pts. |

[Chemical Formula 3]
Polycondensate Polyester G:

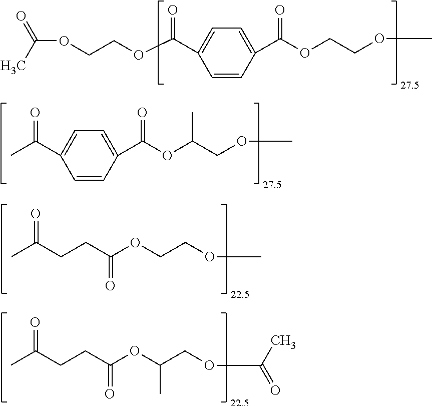

### (Preparation of Mat Agent Solution 602)

The following composition was put into a mixing tank and stirred to dissolve the ingredients, thereby preparing a mat agent solution 602.

Composition of Mat Agent Solution 602

| | |
|---|---|
| Silica particles having a mean particle size of 20 nm | 2.0 mas. pts. |
| (AEROSIL R972, by Nippon Aerosil) | |
| Methylene chloride (first solvent) | 75.0 mas. pts. |
| Methanol (second solvent) | 12.7 mas. pts. |
| Cellulose acylate solution 601 mentioned above | 10.3 mas. pts. |

### (Preparation of Organic Acid Solution 603)

The following composition was put into a mixing tank and stirred under heat to dissolve the ingredients, thereby preparing an organic acid solution 603.

Composition of Organic Acid Solution 603

| | |
|---|---|
| Organic Acid Condensate A-2 | 20.0 mas. pts. |
| Methylene chloride (first solvent) | 67.2 mas. pts. |
| Methanol (second solvent) | 10.0 mas. pts. |
| Cellulose acylate solution 601 mentioned above | 12.8 mas. pts. |

1.3 parts by mass of the mat agent solution 602 and 2.5 parts by mass of the organic acid solution 603 were, both after filtered separately, mixed using an in-line mixer, and 96.2 parts by mass of the cellulose acylate solution 601 was added thereto and further mixed with the in-line mixer, thereby preparing a solution 601 for support-side surface layer.

### <Preparation of Dope 601 for Base Layer>

The cellulose acylate solution 601 was used as the base layer dope.

### <Preparation of Dope 601 for Air-Side Surface Layer>

1.3 parts by mass of the mat agent solution 602 and 98.7 parts by mass of the cellulose acylate solution 601 were mixed with an in-line mixer to prepare a solution 601 for air-side surface layer.

### (Casting)

The dope 601 for support-side surface layer, the base layer dope 601 and the dope 601 for air-side surface layer were cast and laminated on a support in that order. The formed web was peeled from the band. The volatile matter remaining in the peeled film was 40% by mass relative to the solid matter of the film. The peeled film was laterally stretched at a draw ratio of 30%, using a tenter under the condition of 150° C., then unclipped and dried at 135° C. for 20 minutes, thereby producing a polarizer protective film 601. Regarding the thickness of the stretched film, the substrate layer was 54 μm, and the support-side surface layer and the air-side surface layer were 3 μm each. The composition of each layer was shown in Table 6 below. In the following Table 6, the amount of the organic acid was in terms of part by mass relative to 100 parts by mass of the cellulose acylate resin.

### (Measurement of Distribution Ratio of Organic Acid in Film)

The distribution ratio A of the organic acid satisfying the requirements (1) to (3) was determined as follows:

The film was cut obliquely at an angle of 1° relative to the film surface, and the cross section of the thus-cut film was analyzed for mapping with a time-of-flight secondary ion mass spectrometer (TOF-SIMS). In negative measurement, the mean value of the peak intensity of the molecule-H⁺ ion at the part corresponding to a depth of 5 μm from the support-side surface, and the mean value of the peak intensity of the molecule-H⁺ ion at 5 μm from the air-side surface were determined, and the distribution ratio A of the organic acid was calculated according to the following formula:

Distribution Ratio A of Organic Acid=(mean value of the peak intensity on the side having a higher organic acid concentration)/(mean value of the peak intensity on the side having a lower organic acid concentration).

### (Determination of Re, Rth)

The cellulose acylate film produced in Example 601 was analyzed to determine Re and Rth thereof in the same manner as in Example 101. The results are shown in Table 6 below.

### (Determination of Weight-Average Molecular Weight Mw and Mw Change of Cellulose Acylate)

The cellulose acylate film produced in Example 601 was analyzed through high-performance liquid chromatography under the condition mentioned below, thereby determining the weight-average molecular weight of the cellulose acylate.

### Solvent: Tetrahydrofuran.

Column: Shodex K806, K805, K803G (all by Showa Denko—three these columns were connected and used here.)
Column temperature: 25° C.
Sample concentration: 0.1% by mass.

### Detector: RI Model 504 (by GL Science).

### Pump: L6000 (by Hitachi).

Flow rate: 1.0 ml/1 min.
Calibration curve: 13 samples of standard polystyrene, STK Standard Polystyrene (by Tosoh) with Mw of from 500 up to 1000000 were tried to prepare the calibration curve for use herein.

Further, the cellulose acylate film was cut into a sample piece of 3 cm×12 cm, left in an environment at 80° C. and at a relative humidity of 90% for 150 hours, and thereafter this was analyzed according to the above-mentioned method to determine the molecular weight distribution thereof. According to the following formula, the Mw change of the sample was calculated. The results are shown in Table 6 below.

Mw Change=(weight-average molecular weight of cellulose acylate in the film after left at 80° C. and 90% RH for 150 hours)/(weight-average molecular weight of cellulose acylate before aging)×100%.

### [Saponification Treatment of Polarizer Protective Film]

The polarizer protective film of Example 601 produced in the above was immersed in an aqueous solution of 2.3 mol/L sodium hydroxide at 55° C. for 3 minutes. This was washed in a water-washing bath at room temperature, and then neutralized with 0.05 mol/L sulfuric acid at 30° C. Again this was washed in a water-washing bath at room temperature and then dried with hot air at 100° C. Accordingly, the surface of the polarizer protective film of Example 601 was saponified.

### [Production of Polarizer]

A stretched polyvinyl alcohol film was made to adsorb iodine to prepare a polarizing element.

Using a polyvinyl alcohol adhesive, the saponified polarizer protective film of Example 601 was stuck to one side of the polarizing element. A commercially-available cellulose triacetate film (Fujitac TD80UF by FUJIFILM) was saponified in the same manner as above, and using a polyvinyl alcohol adhesive, the thus-saponified cellulose triacetate film was stuck to the other side of the polarizing element to which the polarizer protective film of Example 601 had been stuck.

In this, the polarizing element and the polarizer protective film of Example 601 were so arranged that the transmission axis of the former could be parallel to the slow axis of the latter. In addition, the polarizing element and the commercially-available triacetate film were also so arranged that the transmission axis of the former could be perpendicular to the slow axis of the latter.

In that manner, a polarizer of Example 601 was produced.

### Examples 602 to 609 and Comparative Examples 701 and 702

### Production of Polarizer Protective Films of Examples 602 to 609 and Comparative Examples 701 and 702

Polarizer films of Examples 602 to 609 and Comparative Examples 701 and 702 were produced in the same manner as in Example 601 except that the degree of substitution of the cellulose acylate, the type and the amount of the organic acid, and the film thickness were changed as in Table 6 below. The distribution ratio of the organic acid in each layer, Re and Rth of the films of Examples and Comparative Examples, and the Mw change of the resin were determined, and the data are shown in Table 6 below.

In Table 6 below, the amount of the organic acid is in terms of part by mass relative to 100 parts by mass of the cellulose acylate resin. Citric acid used in Comparative Example 701 is the exemplary compound shown in Japanese Patent 4136054, and the effect of the compound in the patent reference was followed up here.

### [Saponification Treatment of Polarizer Protective Film, and Production of Polarizer]

In the same manner as in Example 601, the polarizer protective films of Examples 602 to 609 and Comparative Examples 701 and 702 were saponified and used for polarizer production, thereby producing polarizers of the respective Examples and Comparative Examples.

### (Evaluation of Polarizer Durability)

The cross transmittance of the polarizing element at a wavelength of 410 nm of the polarizer of Examples and Comparative Examples produced in the above was measured according to the method described hereinabove.

Subsequently, the polarizer was stored in an environment at 60° C. and at a relative humidity of 95% for 300 hours, and then in the same manner as above, the cross transmittance thereof was measured also in the same manner as above. The cross transmittance change of each sample before and after aging was determined, and this is the polarizer durability of the sample. The results are shown in Table 6. The relative humidity in the environment with no conditioning was within a range of from 0% to 20%.

### (Evaluation of Peelability)

The polarizers of the above Examples and Comparative Examples were evaluated for the peelability thereof in the same manner as in Example 101. The results are shown in Table 6.

(Evaluation of Corrosion with Organic Acid)

The polarizers of the above Examples and Comparative Examples were evaluated for the corrosion with organic acid therein in the same manner as in Example 101. The results are shown in Table 6.

TABLE 6

| | | | | Organic Acid | | | | | | |
|---|---|---|---|---|---|---|---|---|---|---|
| | | | | | support-side | | | | air-side | |
| | Cellulose Acetate | | | | surface layer | | base layer | | surface layer | |
| | degree | total degree | amount | | support-side | film | base layer | film | air-side | film |
| | of acetyl | of acyl | added | | surface dope | thickness | dope | thickness | surface dope | thickness |
| | substitution | substitution | (mas. pt.) | compound | (mass part) | [μm] | (mass part) | [μm] | (mass part) | [μm] |
| Example 601 | 2.45 | 2.45 | 100 | Condensate | 3.0 | 3.0 | 0 | 54 | 0 | 3.0 |
| | | | | A-2 | | | | | | |
| Example 602 | 2.45 | 2.45 | 100 | Condensate | 3.0 | 3.0 | 0 | 54 | 0 | 3.0 |
| | | | | A-3 | | | | | | |
| Example 603 | 2.45 | 2.45 | 100 | Condensate | 3.0 | 3.0 | 0 | 54 | 0 | 3.0 |
| | | | | A-4 | | | | | | |
| Example 604 | 2.45 | 2.45 | 100 | Condensate | 3.0 | 3.0 | 0 | 54 | 0 | 3.0 |
| | | | | A-5 | | | | | | |
| Example 605 | 2.45 | 2.45 | 100 | Condensate | 3.0 | 3.0 | 0 | 54 | 0 | 3.0 |
| | | | | C-2 | | | | | | |
| Example 606 | 2.45 | 2.45 | 100 | Condensate | 1.0 | 3.0 | 0 | 54 | 0 | 3.0 |
| | | | | A-2 | | | | | | |
| Example 607 | 2.45 | 2.45 | 100 | Condensate | 0.1 | 3.0 | 0 | 54 | 0 | 3.0 |
| | | | | A-2 | | | | | | |
| Example 608 | 2.45 | 2.45 | 100 | Condensate | 10 | 3.0 | 0 | 54 | 0 | 3.0 |
| | | | | A-2 | | | | | | |
| Example 609 | 2.45 | 2.45 | 100 | Condensate | 5 | 3.0 | 0 | 54 | 0 | 3.0 |
| | | | | A-2 | | | | | | |
| Comparative | 2.45 | 2.45 | 100 | citric acid | 3.0 | 3.0 | 0 | 54 | 0 | 3.0 |
| Example 701 | | | | | | | | | | |
| Comparative | 2.45 | 2.45 | 100 | none | 0 | 3.0 | 0 | 54 | 0 | 3.0 |
| Example 702 | | | | | | | | | | |

| | Organic Acid | | | | | | | | |
|---|---|---|---|---|---|---|---|---|---|
| | average in | | | | Mw Change of | | | | |
| | all layers | | | | Resin [Mw before | | | | |
| | average addition | | Film | | aging/Mw after | Polarizing | Polarizer Durability: cross | | |
| | amount of acid | | Characteristics | | aging × 100%] | Element | transmittance change (%) | | |
| | in all layers | distribution | Re | Rth | 80° C., 90% | Facing | 60° C., 95% | | SUS |
| | (mass part) | ratio A | [nm] | [nm] | RH, 150 hours | Surface | RH, 500 hours | Peelability | Corrosion |
| Example 601 | 0.15 | 1.6 | 52 | 124 | 100 | support | 0.32 | 1 | 1 |
| | | | | | | surface | | | |
| Example 602 | 0.15 | 1.4 | 53 | 122 | 100 | support | 0.30 | 1 | 1 |
| | | | | | | surface | | | |
| Example 603 | 0.15 | 1.3 | 53 | 123 | 100 | support | 0.29 | 1 | 1 |
| | | | | | | surface | | | |
| Example 604 | 0.15 | 1.5 | 54 | 123 | 100 | support | 0.28 | 1 | 1 |
| | | | | | | surface | | | |
| Example 605 | 0.15 | 1.5 | 53 | 123 | 100 | support | 0.31 | 1 | 1 |
| | | | | | | surface | | | |
| Example 606 | 0.05 | 1.3 | 54 | 124 | 100 | support | 0.42 | 1 | 1 |
| | | | | | | surface | | | |
| Example 607 | 0.01 | 1.9 | 54 | 124 | 100 | support | 0.44 | 1 | 1 |
| | | | | | | surface | | | |
| Example 608 | 0.50 | 1.4 | 50 | 120 | 99 | support | 0.20 | 1 | 1 |
| | | | | | | surface | | | |
| Example 609 | 0.25 | 1.3 | 51 | 121 | 100 | support | 0.24 | 1 | 1 |
| | | | | | | surface | | | |
| Comparative | 0.15 | 1.0 | 52 | 122 | 97 | support | 0.38 | 2 | 3 |
| Example 701 | | | | | | surface | | | |
| Comparative | 0 | — | 54 | 124 | 100 | support | 0.44 | 3 | 2 |
| Example 702 | | | | | | surface | | | |

From the results in the above Table 6, it is known that the polarizer using the polarizer protective film of the invention is good as free from the trouble of deterioration of the polarizing element therein after aging in high-temperature high-humidity environments. In addition, it is also known that the resin film of the invention is good as free from the trouble of molecular weight reduction of the resin even after stored in high-temperature high-humidity environments. It is further known that the resin film of the invention containing the organic acid that satisfies the requirements (1) to (3) has good peelability and hardly corrodes SUS, and is therefore favorable in point of producibility.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2011-166958, filed on Jul. 29, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A resin film comprising a resin and from 0.01% by mass to 20% by mass, relative to the resin, of an organic acid satisfying the following requirements (1) to (3):
(1) The organic acid comprises structure in which a polyalcohol bonds to a polycarboxylic acid via an ester bond,
(2) The total number of the molecules of the polyalcohol and the polycarboxylic acid forming the organic acid is at least 3, and
(3) The organic acid has at least one unsubstituted carboxylic acid derived from the polycarboxylic acid.

2. The resin film according to claim 1, which comprises a cellulose acylate in an amount of from 5 to 99% by mass as the resin.

3. The resin film according to claim 2, wherein the total degree of acyl substitution of the cellulose acylate is 1.0 or more to less than 2.6.

4. The resin film according to claim 1, wherein the concentration of the organic acid satisfying the requirements (1) to (3) in the region to a depth of 5 μm from one film surface, and the concentration of the organic acid satisfying the requirements (1) to (3) in the region to a depth of 5 μm from the other film surface satisfy the relationship of the following formula (4):
1.2≦(mean concentration of the organic acid in the region to a depth of 5 μm from the film surface on the side of the film on which the concentration of the organic acid is higher)/(mean concentration of the organic acid in the region to a depth of 5 μm from the film surface on the side of the film on which the concentration of the organic acid is lower)≦5.0. (4)

5. A method for producing a resin film, which comprises casting a dope that comprises a resin and from 0.01% by mass to 20% by mass, relative to the resin, of an organic acid satisfying the following requirements (1) to (3), onto a metal support to form a dope film thereon, and peeling the dope film from the metal support:
(1) The organic acid comprises a structure in which a polyalcohol bonds to a polycarboxylic acid via an ester bond,
(2) The total number of the molecules of the polyalcohol and the polycarboxylic acid forming the organic acid is at least 3, and
(3) The organic acid has at least one unsubstituted carboxylic acid derived from the polycarboxylic acid.

6. The method for producing a resin film according to claim 5, wherein the resin comprises cellulose acylate in an amount of from 5 to 99% by mass.

7. The method for producing a resin film according to claim 6, wherein the total degree of acyl substitution of the cellulose acylate is 1.0 or more to less than 2.6.

8. The method for producing a resin film according to claim 5, wherein dopes for at least two layers are co-cast onto the metal support, and the organic acid satisfying the requirements of (1) to (3) is added to any one of the dope for the layer to be kept in contact with the metal support surface or the dope for the layer to be on the air interface side.

9. A resin film produced by the method for producing a resin film of claim 5.

10. A polarizer protective film comprising the resin film of claim 1.

11. A polarizer comprising at least one polarizer protective film of claim 10.

12. A liquid crystal display device comprising the polarizer protective film of claim 10.

13. A liquid crystal display device comprising the polarizer of claim 11.
